(19) United States
(12) Patent Application Publication
(10) Pub. No.: US 2026/0154906 A1
(43) Pub. Date: Jun. 4, 2026

(54) PROCESSING OF THREE-DIMENSIONAL SCANS AND PROGRESS VISUALIZATIONS

(71) Applicant: Occipital, Inc., Denver, CO (US)

(72) Inventors: Anton Anatolievich Yakubenko, Saint Johns, FL (US); Yuriy Evgenevich Berdnikov, Belgrade (RS); Oleg Olegovich Kazmin, Zhukovsky (RU); Dmytro Korbut, Dnipro (UA); Gleb Robertovich Krivovyaz, Zurich (CH); Timur Shahinivich Ibadov, Baku (AZ)

(21) Appl. No.: 19/404,327

(22) Filed: Dec. 1, 2025

Related U.S. Application Data
(60) Provisional application No. 63/726,793, filed on Dec. 2, 2024.

(51) Int. Cl. G06T 17/20; G06T 7/70; G06T 15/04

(52) U.S. Cl. CPC G06T 17/20; G06T 7/70; G06T 15/04; G06T 2207/30244

(57) ABSTRACT

Systems and methods for processing three-dimensional scans and providing visualizations to a user as to the progress associated with rendering a final model. In some examples, a device may receive frames and position data during scanning, estimates frame poses using visual-inertial tracking, and merges consecutive frames into viewpoint bundles. The system generates preliminary visualizations including solid mesh, wireframe, point cloud, and/or stylized model visualizations that may be overlayed on the view of the camera during the scanning operations. In this example, the user may engage with the preliminary visualizations while post-processing operations are executed. In some cases, the system may provide secondary visualizations to the display as particular operations associated with the post processing complete prior to displaying the final three-dimensional model.

### CROSS-REFERENCE TO RELATED APPLICATION

This application claims priority to U.S. Provisional Application No. 63/726,793 filed on Dec. 2, 2024 and entitled “IMPROVED PROCESSING OF THREE-DIMENSIONAL SCANS AND PROGRESS VISUALIZATIONS,” which is incorporated herein by reference in its entirety.

### BACKGROUND

Today, the democratization of three-dimensional (3D) scanning is underway as professional laser scanners become more affordable and 3D sensing technologies, such as lidar are integrated into consumer electronic devices. This shift has created a high demand for rapid processing of scans, particularly on mobile devices. Historically, conventional systems for generation of a final 3D scan or model from captured sensor data, such as depth, image, and/or video data, have been time-consuming and resource-intensive. Conventional approaches often require significant computational resources and extended processing times to convert raw sensor data into usable 3D models. These limitations may be particularly pronounced when processing occurs on mobile devices with constrained processing power, memory, and battery life. Furthermore, users may experience frustration when waiting for scan processing to complete, as conventional systems may provide limited or no feedback regarding processing progress. Accordingly, there is a growing need to accelerate 3D data processing and provide improved user experiences during scan processing operations.

### BRIEF DESCRIPTION OF FIGURES

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is an example block diagram of a system for processing three-dimensional scans and generating progress visualizations according to some implementations.

FIG. 2 is an example block diagram of a device or system associated with scanning operations performed during a scanning session and for processing three-dimensional scans during scanning operations according to some implementations.

FIG. 3 is an example block diagram of post processing operations for processing three-dimensional scans according to some implementations.

FIG. 4 is an example block diagram of a device for processing three-dimensional scans according to some implementations.

FIG. 5 is a flow diagram illustrating an example process for managing viewpoint bundles during three-dimensional scanning operations according to some implementations.

FIG. 6 is a flow diagram illustrating an example process for generating and texturing high-polygon meshes during post-processing operations according to some implementations.

FIG. 7 is a flow diagram illustrating an example process for adjusting camera orientation during three-dimensional scanning visualization operations according to some implementations.

FIG. 8 is a flow diagram illustrating an example process for managing dynamic camera adjustments during three-dimensional scanning visualization operations according to some implementations.

FIG. 9 is a flow diagram illustrating an example process for mesh orientation alignment during three-dimensional scanning visualization operations according to some implementations.

FIG. 10 is a flow diagram illustrating an example process for determining floors of a viewpoint bundle and merging viewpoint bundle meshes during three-dimensional scanning operations according to some implementations.

FIG. 11 illustrates visualization and ordination of model feedback during a scanning session showing the progressive development of preliminary visualizations on a mobile device display according to some implementations.

FIG. 12 illustrates a mesh visualization of a physical environment that may be generated as part of three-dimensional scanning and visualization operations according to some implementations.

FIG. 13 illustrates a vertex visualization of a physical environment that may be generated during three-dimensional scanning and visualization operations according to some implementations.

FIG. 14 illustrates a wireframe visualization of a physical environment that may be generated during three-dimensional scanning and visualization operations according to some implementations.

FIG. 15 illustrates a point cloud visualization of a physical environment that may be generated during three-dimensional scanning and visualization operations according to some implementations.

FIG. 16 illustrates a point cloud and directional light visualization of a physical environment that may be generated during three-dimensional scanning and visualization operations according to some implementations.

FIG. 17 illustrates an animated point cloud visualization of a physical environment that may be generated during three-dimensional scanning and visualization operations according to some implementations.

FIG. 18 illustrates another point cloud visualization of a physical environment that may be generated during three-dimensional scanning and visualization operations according to some implementations.

FIG. 19 illustrates a combined mesh and point cloud visualization of a physical environment that may be generated during three-dimensional scanning and visualization operations according to some implementations.

FIG. 20 illustrates a final mesh visualization of a physical environment that may be generated upon completion of three-dimensional scanning, visualization and post-processing operations according to some implementations.

FIG. 21 illustrates a three-dimensional doll house view of a scanned interior physical environment that may be generated as part of finalized visualization operations according to some implementations.

FIG. 22 illustrates user interfaces showing different display modes for viewing a three-dimensional scan of a physical environment according to some implementations.

FIG. 23 illustrates a progress bar or status visualization showing progressive visualization development during three-dimensional scanning, during visualization, and/or during post processing operations according to some implementations FIG. 24 illustrates a top-down point cloud visualization of a physical environment that may be generated during three-dimensional scanning and visualization operations according to some implementations.

FIG. 25 illustrates a multistory building visualization including a first floor visualization, a second floor visualization, and a multistory building visualization according to some implementations.

FIG. 26 illustrates a scanning session visualization sequence showing progressive model updates according to some implementations.

FIG. 27 illustrates a transition visualization that may be generated during initial post-processing operations or later stages of a scanning session according to some implementations.

FIG. 28 illustrates a scanning session visualization sequence showing progressive visualization development during post processing operations according to some implementations.

FIG. 29 illustrates a block diagram of a system for processing three-dimensional scans and generating progress visualizations according to some implementations.

### DETAILED DESCRIPTION

Discussed herein are three-dimensional (3D) scan processing methods and systems for generating, processing, and/or visualizing 3D scans and models of physical environments and objects as well as progress indicators to inform and set expectations of users as to a status and progress of model generation. Today, many user devices are equipped with high quality image capture and depth determination sensors, such as lidar systems. The availability of the high quality sensors and high quality image and depth data has created a high demand for rapid scan processing, particularly on mobile devices. Historically, conventional systems for generation of a final 3D scan or model from captured sensor data, such as depth, image, and/or video data from a user device (such as a mobile device), have been time-consuming and resource-intensive. Accordingly, there is a growing need to accelerated 3D data processing, such as discussed herein.

In some examples, the system discussed herein may be configured to provide progress visualization during scan processing to improve user engagement and experience. Users can become frustrated with software processing operations, particularly without having a real understanding or indication of the status, time to completion, and/or operations being performed. Accordingly, the system, discussed herein, is configured to provide visualization during scanning and processing of the captured sensor data. While a conventional progress bar can be used, more informative visualization offers greater utility and engagement and increased user understanding and patience while the model generation operation is performed. For example, the systems and methods, discussed herein, may allow users to view a preliminary or work-in-progress 3D model to view or otherwise engage with during processing. The preliminary 3D model may enable users to assess the quality of the scan, identify any missing areas or sections of the scan that are deemed of insufficient quality, lacking data, and/or the like and perform additional scans or data capture as the user desires while the final 3D scan is still being generated. Accordingly, the user is able to be more proactive during the generation process rather than simply being disappointed after waiting for the final model to be generated and receiving an output of a low quality final 3D model (even when the low quality is a result of poor scanning operations performed by the user). Rather, the feedback visualization provided by the preliminary 3D model allows the user to be involved and engaged during processing to actively impact the quality of the final 3D model in a manner that may be rewarding and/or satisfying to the user while concurrently producing higher quality 3D models in less time.

In some examples, the systems and methods, discussed herein, may be configured to process 3D scans for various physical environments or spaces, including interior and exterior residential and commercial environments, as well as objects occupying the physical environment. In some cases, the systems and methods described apply to a wide range of scanning devices and various input and output data types. In some cases, the system may include processing capabilities for scans captured on mobile devices and visualizing the processing progress on those devices. In some cases, these processing capabilities may include an enumeration of various features or elements, such as walls, doors, windows, openings, furniture, structural or functional components, objects in the physical environment, and/or the like.

For example, in some cases, the systems and methods, discussed herein, may be configured to provide improved visualization feedback by performing operations associated with 3D model generation during the scanning or data capture events. For instance, during scanning, position and orientation sensors, such as inertial measurement units (IMUs), associated with the capture device may provide IMU data to a visual-inertial tracker system that may be configured to estimate frame poses of the capture device corresponding to each frame of the image data and/or depth data captured by the device. In some implementations, the visual-inertial tracker system may utilize various algorithms and techniques such as extended Kalman Filters (EKF), particle filters, bundle adjustment, feature detection and matching algorithms (such as Oriented FAST and Rotated BRIEF (ORB), Scale-Invariant Feature Transform (SIFT), or Speeded Up Robust Features (SURF), optical flow estimation, keyframe-based tracking, loop closure detection, graph optimization methods, and/or the like. In some aspects, the visual-inertial tracker system may utilize simultaneous localization and mapping (SLAM) techniques to track the device's movement through the physical environment while concurrently building a map of the scanned area. The frame poses may include position and orientation information that describes the spatial relationship between the capture device and the physical environment at the time each frame was captured.

In some cases, the pose estimates may be used to align and register multiple frames of sensor data, enabling the system to begin constructing a preliminary 3D model of the scanned environment in substantially real-time and concurrently with the scanning event. In this manner, the preliminary 3D model may be continuously updated and refined as additional sensor data is captured, allowing users to observe the evolving model as the user scans the physical environment. In some examples, the system may perform depth fusion operations to combine depth information from multiple frames, potentially improving the accuracy and completeness of the preliminary model. The real-time processing capabilities may enable users to identify areas that require additional scanning coverage or improved data quality before completing the scanning session, thereby reducing the likelihood of needing to rescan the environment at a later time.

In some implementations, the estimated frame poses of the device and image and depth data from consecutive frames with close world positions may be merged into a viewpoint bundle (VB). In this manner, the viewpoint bundle may serve as an accumulated storage for a sequence of depth frames. In some aspects, the viewpoint bundle may be represented in a mesh format that facilitates efficient storage and processing of the accumulated depth information. In some cases, the system may continue to update a single or active viewpoint bundle as long as a pose difference between a first frame of the viewpoint bundle and a currently arrived frame is less than or equal to a threshold (e.g., distance threshold in one or more of the six degrees of freedom, number of frames threshold, amount total data associated with the viewpoint bundle threshold, period of time threshold, and/or the like). After reaching the threshold, the current viewpoint bundle may proceed to further processing for the preliminary and/or final 3D model and a new viewpoint bundle may be created and data accumulation may be started anew.

In some cases, the viewpoint bundle approach may provide several advantages for substantially real-time 3D model generation. The bundling of frames with similar poses may reduce computational overhead by avoiding redundant processing of overlapping depth data while maintaining spatial coherence within each bundle. In some examples, the threshold for pose difference may be configurable based on factors such as the scanning environment, desired model resolution, or available computational resources. The mesh representation of the viewpoint bundle may enable efficient rendering and visualization of the preliminary 3D model as the preliminary 3D model is output allowing users to observe the progressive construction of the scanned environment.

In some implementations, the system may manage multiple viewpoint bundles concurrently, such as with each viewpoint bundle representing a distinct spatial region or viewing perspective of the scanned environment. As new viewpoint bundles are created and completed, the system may perform registration and alignment operations to integrate the individual bundles into a cohesive preliminary 3D model. This approach may allow for parallel processing of different spatial regions, potentially accelerating the overall model generation process while maintaining the ability to provide continuous visual feedback to the user during scanning operations.

In some implementations, once a viewpoint bundle is completed (e.g., the threshold is met or exceeded), a plane detection process or operation may commence in the background of the capture device (while the user is still scanning via the device) to extract 3D planes present in captured geometries associated with the viewpoint bundle. In some cases, the captured geometries may correspond to walls, ceilings, floors, and/or other large flat surfaces. In some examples, the plane detection process may operate concurrently with other processing operations, allowing the system to identify and characterize planar surfaces without interrupting the ongoing scan. In some aspects, the plane detection process may utilize various computational geometry techniques, such as Random Sample Consensus (RANSAC), Hough transforms, region growing algorithms, or machine learning-based approaches to identify and segment planar regions within the captured depth data. In some examples, the extracted plane information may be used to refine surface representations, reduce noise in the preliminary 3D model, or provide semantic labeling of architectural elements within the final 3D model of the scanned physical environment.

In some implementations, once the plane detection is completed for a viewpoint bundle, global viewpoint bundle pose optimization may commence based on an accumulated global viewpoint bundle associated with the 3D model and the recently captured viewpoint bundle. In some aspects, the global pose optimization may utilize nonlinear optimization techniques (such as Levenberg-Marquardt algorithm, Gauss-Newton method, bundle adjustment, graph-based optimization methods like pose graph optimization, or iterative closest point (ICP) algorithms, and/or the like) to fine-tune viewpoint bundle poses and refine possible tracker inaccuracies by incorporating prior knowledge about possible scene or model structure. In some cases, the optimization process may help address cumulative drift errors that may occur on device during extended scanning sessions and improve the overall geometric consistency of the generated 3D models.

In some examples, the global pose optimization may employ various constraints that reflect the structural characteristics commonly found in physical environments. These constraints may include, but are not limited to, several geometric and spatial relationships. In some cases, a flat plane constraint may be applied, where closely matched planes detected across different viewpoint bundles are expected to lie on the same global plane. This constraint may help ensure that surfaces such as walls, floors, or ceilings maintain geometric consistency across multiple viewpoint bundles, even when captured from different perspectives or at different times during the scanning process. In some implementations, a Manhattan world constraint may be utilized, where large global planes are expected to be parallel or perpendicular to each other in most cases. This constraint may reflect the predominant architectural design principles found in many built environments, where walls, floors, and ceilings typically follow orthogonal relationships. The Manhattan world assumption may be particularly useful for indoor environments and structured outdoor spaces, helping to regularize the pose optimization process and improve the geometric accuracy of the resulting 3D model. In some aspects, a room overlap constraint may be applied, where planes that belong to different sides of the same wall should not intersect and may maintain a measurable minimal distance between them. The room overlap constraint may help prevent geometric inconsistencies that could arise from pose estimation errors, ensuring that the thickness of walls and other structural elements is properly represented in the 3D model. The room overlap constraint may also help maintain the topological correctness of the scanned environment, preventing impossible geometric configurations that could degrade the quality of the final 3D model.

In some cases, to maintain substantially real-time performance during the scanning process, the global pose optimization may be constrained by computational limitations, particularly the number of optimization iterations that may be performed within the available processing time budget. The system may implement iteration limits to ensure that the optimization process does not introduce significant delays that result in users loss of understanding of the status of the generation process. For example, the system may select the iteration limits to ensure the preliminary 3D model visualization does not lag behind the ongoing scanning operations. In some implementations, the iteration limit may be dynamically adjusted based on factors such as the computational capacity of the device, the complexity of the scene being scanned, the number of viewpoint bundles being processed, or the desired balance between optimization accuracy and processing speed.

In some implementations, the newly updated viewpoint bundle may be utilized to generate substantially real-time mesh overlay visualizations that are presented to the user during the scanning process. The mesh overlay visualization may provide users with an immediate visual representation of the evolving 3D model, incorporating the geometric refinements achieved through the pose optimization process. In some cases, the mesh overlay may be rendered as a semitransparent or wireframe representation that overlays the live camera feed, allowing users to observe both the physical environment and the corresponding 3D model simultaneously (and thereby, in some cases, inform scanning operations performed by the user). In some aspects, the real-time mesh overlay may enable users to assess the quality and completeness of the scan as the user captures data associated with the physical environment.

In some implementations, once a scan is complete, the system may commence with postprocessing of the captured data. In this implementation, the user may be able to actively engage with and consume the preliminary 3D model while the final 3D model is generated via postprocessing (such as on-device, as a cloud-based operation, and/or a cloud-assisted operation, and/or the like). For example, postprocessing may include viewpoint bundle voxel data reintegration with the latest optimized viewpoint bundle pose may be performed to ensure that the accumulated depth information reflects the refined spatial positioning determined during the pose optimization process. In some cases, this reintegration step may help correct any geometric distortions that may have accumulated during the scanning phase, potentially improving the overall accuracy of the depth data before subsequent processing operations.

In some cases, the postprocessing may also include merging all viewpoint bundles'data together by, for instance, subdividing the entire scanning volume into partitions. In some cases, the partitions may be processed individually to satisfy memory requirements of the processing device. The size of each partition may be determined based on device capabilities, including available memory, processing power, computational resources, and storage capacity of the processing device. In some examples, the partitioning may enable the device to handle large-scale environments that might otherwise exceed available memory resources, while maintaining processing efficiency across different hardware configurations. In some cases, the partition size may be dynamically determined based on available system resources, the complexity of the scanned geometry, or the desired balance between processing speed and memory utilization. In some implementations, a high-resolution mesh may be constructed for each individual partition. In this implementation, each of the meshes may be merged into a final high-polygon 3D mesh. The partition-based mesh generation may allow for parallel processing of different spatial regions, potentially reducing overall processing time while maintaining geometric continuity across partition boundaries. In some examples, the merging process may include alignment and blending operations to ensure seamless transitions between adjacent partitions in the final mesh.

In some cases, the high-polygon mesh may be simplified to target a specific number of faces while preserving as many details as possible. The mesh simplification process may utilize various algorithms such as quadric error metrics, edge collapse operations, or vertex clustering techniques to reduce geometric complexity while maintaining visual fidelity. In some aspects, the target face count may be configurable based on the intended use case, available storage capacity, or performance requirements of the target application or device.

In some implementations, small holes existing in the resulting mesh, such as from unscanned areas of the physical environment, may be filled by, for example, geometry interpolation techniques. In some cases, the hole-filling process may employ various computational geometry techniques, such as Poisson surface reconstruction, radial basis function interpolation, or patch-based completion methods to generate plausible surface geometry in areas where sensor data may be incomplete or unavailable. In some examples, the interpolation process may consider surrounding surface characteristics and geometric patterns to generate visually coherent completions.

In some examples, plane detection may be performed and vertices belonging to the same plane may be aligned to improve visual mesh quality and reduce visual noise on large flat areas. The plane alignment process may help create cleaner, more geometrically accurate representations of architectural surfaces such as walls, floors, and ceilings. In some cases, the plane detection and alignment operations may utilize the previously detected plane information from the real-time processing phase (e.g., operations performed during the scanning session or event), potentially refining and extending those results with the complete dataset.

In some implementations, keyframes may be selected for texturing based on their data redundancy and visual area overlap. This selection process may allow the system to speed up texturing by selecting a reasonable amount of the most valuable frames as a data source from the total frame count captured during scanning. In some examples, the keyframe selection algorithm may consider factors such as image quality, viewing angle, lighting conditions, and spatial coverage to identify frames that provide optimal texture information for the 3D model.

In some cases, texture patches for individual frames may be selected from available keyframes and merged into texture atlases. The texture atlas generation process may involve seam minimization and color blending operations to create cohesive texture representations that accurately reflect the visual appearance of the scanned environment. In some aspects, the texture atlas approach may enable efficient rendering and storage of the textured 3D model while maintaining visual quality across different viewing perspectives.

In some cases, processed scans may be reprocessed or otherwise improved after initial processing operations have been completed. The reprocessing capabilities may enable users to enhance scan quality, apply different processing parameters, or leverage improved algorithms that become available after the initial processing. In some implementations, reprocessing may be triggered through various mechanisms depending on user needs and system capabilities.

In some examples, scans may be uploaded to cloud servers or transferred to another device for reprocessing. The cloud-based or remote device processing may provide access to enhanced computational resources, advanced algorithms, or longer processing times that may not be available or practical on the original capture device. In some aspects, the system may facilitate seamless data transfer and processing coordination between the capture device and remote processing resources. In some cases, processing may be stopped and restarted either on the same device or on other devices, such as the cloud-based remove device. In some examples, the restarting may be from scratch or back from the original captured sensors data.

In some cases, scans may be reprocessed on the same device where the scan was originally captured. The on-device reprocessing may be performed for a longer duration compared to the initial processing, potentially in the background while the device is idle or charging. In some implementations, the extended processing time may enable more computationally intensive algorithms or higher iteration counts for optimization operations, potentially resulting in improved geometric accuracy or visual quality of the final 3D model.

In some aspects, reprocessing may be initiated by user action. Users may manually request reprocessing of a scan through user interface controls or settings, potentially specifying desired processing parameters or quality targets. In some cases, the system may provide options for users to select different processing modes, algorithm variants, or quality levels when initiating reprocessing operations.

In some implementations, a reprocessed or improved scan may be displayed or otherwise presented to the user upon completion of the reprocessing operations. The system may provide visualization capabilities that enable users to compare the original processed scan with the reprocessed version, potentially highlighting improvements in geometric accuracy, texture quality, or other quality metrics. In some cases, the presentation of reprocessed scans may include notifications or indicators that inform users about the enhancements achieved through reprocessing.

In some examples, the system may implement limits or thresholds on the number of attempts a scan may be processed. The attempt limits or threshold may help manage computational resources, prevent excessive processing costs, or ensure reasonable system performance across multiple users or scans. In some aspects, the attempt limit or threshold may be configurable based on factors such as user account type, subscription level, scan complexity, or available system resources.

In some cases, the user may be notified about each processing attempt or selected attempts, as well as the number of attempts remaining. The notifications may provide transparency regarding processing status and help users understand the constraints or limitations associated with scan processing operations. In some implementations, the notification system may display information through user interface elements, push notifications, email messages, or other communication channels.

In some aspects, if some or all processing attempts fail, alternative solutions may be triggered automatically or offered to the user. The alternative solutions may provide fallback options that increase the likelihood of successful scan processing or offer users different approaches to achieve their desired outcomes. In some cases, the system may automatically initiate alternative processing strategies when initial attempts fail, potentially without requiring explicit user intervention.

In some examples, alternative solutions may include uploading the scan to cloud servers or another device for processing. The cloud-based or remote processing may provide access to more robust computational infrastructure or specialized processing capabilities that may address the issues encountered during failed processing attempts on the original device. In some implementations, the system may automatically prepare and initiate the upload process when local processing attempts are exhausted.

In some cases, alternative solutions may include running processing operations on the original device with different algorithms, modified parameters, or extended processing duration. The system may attempt alternative processing configurations or settings that may be more suitable for the specific characteristics of the scan data or the constraints of the processing environment. In some aspects, the modified processing approach may involve reduced quality targets, simplified algorithms, or adjusted memory management strategies that increase the likelihood of successful completion.

In some aspects, stopping processing operations at on demand may be complicated or difficult due to the nature of certain processing algorithms or data structures. In some cases, processing operations may need to complete certain atomic operations or reach specific checkpoints before interruption may be safely performed without data corruption or inconsistent state. In some implementations, when immediate interruption is not feasible, notifications may be shown to the user to communicate the processing status and expected wait time.

In some examples, the system may display notifications such as loading spinners, progress indicators, or text messages that inform users about ongoing processing operations. The notifications may include messages such as “Please wait until another scan finishes processing before starting a new one. This usually takes less than 30 seconds” or similar communications that set appropriate expectations regarding processing completion. In some cases, the notification system may provide estimated time remaining or other contextual information that helps users understand the current processing state.

In some implementations, processing operations may require large amounts of memory or storage resources. The memory and storage requirements may vary based on factors such as scan size, resolution, processing algorithms, or intermediate data structures utilized during processing operations. In some aspects, the system may monitor resource utilization and available capacity to ensure that processing operations may be completed successfully without exhausting system resources.

In some cases, notifications may be displayed to the user regarding memory or storage utilization. The notifications may communicate information such as the amount of RAM or disk space currently used by processing operations, the amount of available resources remaining, and/or warnings when resource utilization approaches certain thresholds. In some examples, the system may display notifications when users approach resource limits that may impact processing performance or completion. The resource notifications may enable users to take proactive actions such as freeing up storage space, closing other applications, or transferring data to external storage before initiating or continuing processing operations. In some implementations, the notification system may provide recommendations or automated options for managing resource constraints, potentially including temporary file cleanup, data compression, or alternative processing configurations that reduce resource requirements.

As discussed above, the systems and methods provide for improved user feedback during the processing of the 3D models, including during the postprocessing operations. For example, the systems and methods may provide various forms of intermediate visualization and feedback to users during the postprocessing operations. In some implementations, while the 3D scan is being processed, intermediate results may be obtained and displayed to the user to maintain engagement and provide ongoing feedback regarding processing progress.

In some cases, the intermediate results may be displayed using various 3D representation formats. The system may render the evolving model as a solid mesh, wireframe, point cloud, or other suitable 3D representation depending on the current processing stage and available data. In some aspects, the visualization may incorporate stylization techniques such as voxelized representations that provide a pixelated aesthetic, line-based renderings, contour visualizations, sketch-like presentations, surfel-based displays, surface representations, or splat-based rendering methods. These varied visualization approaches may help convey different aspects of the processing progress while maintaining visual interest for the user.

In some implementations, the intermediate visualizations may be presented with or without colors and textures. The system may display the model using a single uniform color or may apply various coloring schemes based on different criteria. In some examples, height-based coloring may be employed, where points or surfaces at greater elevations are rendered with warmer colors, creating an intuitive visual representation of the spatial characteristics of the scanned environment. In some cases, quality-based coloring may be utilized, where areas with higher data quality or confidence levels transition from red to green coloring, providing users with immediate feedback regarding the reliability of different regions within the scan. In some aspects, semantic-based coloring may be applied, where different object types such as walls, doors, windows, furniture, or other architectural elements are assigned distinct colors to enhance the interpretability of the evolving model.

In some cases, the color information may be processed or modified to enhance the visualization effectiveness. Colors may be converted to grayscale or reduced to a more limited color palette to improve visual clarity or accommodate different display capabilities. In some implementations, color processing operations such as contrast and brightness adjustments may be applied to increase visual distinction between different processing stages or to highlight changes as the visualization type evolves. In some aspects, the visualization may incorporate varying levels of opacity or transparency, with transparency levels potentially corresponding to the current processing stage or confidence level of different model regions.

In some examples, the mesh or model representation may utilize various polygon counts or point densities depending on the resolution available during different stages of the processing pipeline. The system may dynamically adjust the level of detail based on the current processing state, available computational resources, or user preferences. In some cases, points, lines, voxels, and other geometric primitives may be rendered with different sizes, thicknesses, and visual parameters to optimize the visualization for the current processing context.

In some implementations, the system may perform back-face culling operations to improve visual clarity and rendering performance. When displaying points, edges, wireframes, or other primitives besides polygons, the system may hide primitives associated with polygons that would not be visible due to back-face culling. In some aspects, the system may analyze the orientation of each triangle in the scan relative to the viewer's perspective, identifying and excluding triangles facing away from the camera from the rendering process. This technique may be consistently applied across various visualization styles, including full-colored mesh representations, grayscale wireframes, and point cloud visualizations. In some cases, back-face culling may serve to reduce visual clutter and improve the readability and interpretability of architectural details within the scan data.

In some examples, additional processing operations may be applied to the intermediate results before display to the user. These operations may include sampling techniques such as down-sampling, up-sampling, and resampling to adjust the data density for optimal visualization. In some cases, filtering operations may be applied to reduce noise or enhance specific features within the intermediate model. The system may perform simplification operations to reduce geometric complexity while maintaining visual fidelity, or apply hole filling techniques to address gaps in the intermediate representation. In some implementations, planarization operations may be performed to improve the representation of flat surfaces within the evolving model. In some aspects, the system may display only a certain number or percentage of available points to balance visual quality with rendering performance.

In some cases, the system may extract and utilize higher-level geometric and semantic information for enhanced visualization. The intermediate visualizations may incorporate identified architectural elements such as walls, doors, windows, cabinets, furniture, appliances, and other objects within the scanned environment. In some implementations, this semantic information may be used to provide more informative and contextually relevant progress feedback, allowing users to observe not only the geometric reconstruction progress but also the system's understanding of the functional and structural elements within the scanned physical environment or space.

In some implementations, the systems and methods may include various viewing improvements, such as a completion state of the preliminary 3D model and/or the final 3D model. For example, the preliminary and/or intermediate results may be displayed in various viewing modes, including a doll-house view or first-person view, as well as top-down views utilizing parallel or orthogonal projections. In some implementations, the type of view may be dynamically selected based on the current stage or progress of the processing operations. For example, the system may initially display a grayscale point cloud in a 2D top-down view and then transition to a 3D doll-house view of a colorized wireframe.

In some aspects, viewing capabilities may be intentionally limited to enhance the user experience and maintain visual quality standards. The system may restrict or prohibit certain user interactions such as zoom, pan, or orbit operations to prevent users from observing imperfections or artifacts in the preliminary and/or intermediate results that could negatively impact a user's perception of the processing quality. In some cases, the limitations may be progressively relaxed as the model quality improves throughout the processing pipeline.

In some implementations, the position, orientation, and scale of the displayed portion of the scan may dynamically change to optimize the viewing experience. The system may dynamically adapt the viewing perspective based on both the aspect ratio of the scanned object and the display device's screen proportions. In some examples, the system may analyze the ratio between the width and height of a bounding box of the object in relation to the aspect ratio of the device's screen. In some cases, when these ratios are mismatched, the system may automatically adjust the camera's orientation by swapping coordinate axes, such as the x-axis and z-axis. This adaptive approach may ensure optimal visualization experience and screen area utilization regardless of the device used for viewing.

In some implementations, the scan may be oriented along a main axes such that the axes are aligned with the display axes, providing a more intuitive and standardized viewing experience. In some cases, the mesh orientation algorithm may iteratively update a current rotation estimate starting from a provided initial estimate. The number of iterations may be fixed or may be dynamically determined based on convergence criteria or computational constraints. In some aspects, each iteration of the orientation algorithm may consist of several operations. The system may assign each mesh face's normal vector to the nearest primary axis (X, Y, Z) of the current rotation estimate. In some examples, the system may calculate a weighted sum of assigned normals to each axis, where the weight for each normal may take into account factors such as the face area and the angle between the normal and the axis. In some implementations, the exact weight calculation methods may vary depending on the iteration number to ensure robustness and convergence of the optimization process. The current rotation estimate may then be updated to minimize angle mismatch between its primary axes and the normals'weighted average with the help of least-squares optimization techniques.

In some cases, as discuses above, the visualization may automatically rotate, move, or zoom to enhance the viewing experience. For example, a 3D doll-house view may automatically spin or rotate around the model, providing users with a comprehensive perspective of the scanned environment without requiring manual interaction. In some implementations, the automatic movement may be synchronized with the processing progress, potentially creating a dynamic presentation that evolves as the model develops. In some examples, the visualization may be presented on a variety of backgrounds to enhance visual appeal and context. The background may be dependent on the scan data associated with the current scan.

In some aspects, as the scanned mesh progressively grows through time, simulating the data acquisition process during the scan, the system may dynamically adjust the camera zoom level and central focus point to maintain optimal framing of the expanding mesh. This dynamic zooming approach may ensure that the entire mesh remains visible within the display area, preventing any portions from being obscured or truncated. In some implementations, the zoom and pan adjustments may be calculated based on the bounding box dimensions of the mesh, which may continuously update as new data points are added. The system may dynamically scale the view to encompass the evolving bounding box, potentially guaranteeing that the user maintains a comprehensive and unobstructed view of the scanned object throughout the reconstruction process.

In some cases, to ensure a seamless and visually pleasing user experience, transitions in camera position and zoom may be executed with smooth, continuous adjustments. The animation system may predict the state of the scan's bounding box at a future point in time, such as 500 milliseconds later, 1000 milliseconds later, and/or similar future time intervals. In some implementations, the system may then interpolate the camera or imaging device parameters between the current bounding box and the predicted bounding box, resulting in a gradual and unobtrusive shift in perspective as the scan progresses. This interpolation method may minimize abrupt camera movements, potentially providing a more comfortable and immersive viewing experience for the user throughout the reconstruction process.

In some implementations, the system may support progressive or dynamic visualization approaches where different geometric elements are displayed in a specific sequence. The visualization order may be based on various criteria that reflect the data acquisition or processing workflow. In some cases, polygons, points, lines, voxels, or other geometric primitives may be visualized based on the sequence or time in which the corresponding frames or data were captured during the scanning process. Accordingly, users could observe how the reconstruction process of the 3D model would have unfolded during the original scanning session. In some aspects, the visualization order may follow the order or sequence in which data appears in the file or another representation of the scan, potentially providing a systematic progression through different spatial regions or processing stages of the model.

In some examples, color, size, or other properties of the visualized primitives may be changed progressively during the visualization process. In some cases, the visualization may initially present a grayscale point cloud representation and then transition to a colorized point cloud as additional processing operations are completed. In some implementations, the progressive property changes may include modifications to point sizes, line thicknesses, transparency levels, or surface reflectance properties to provide visual feedback about the evolving quality and completeness of the reconstruction.

In some aspects, the type of primitives may be changed progressively throughout the visualization sequence. The system may begin by displaying a point cloud representation of the scanned data and then transition to a wireframe mesh visualization as geometric connectivity information becomes available. In some cases, the progression may continue to a solid mesh representation once surface reconstruction operations are completed. In some implementations, this primitive type progression may reflect the underlying processing pipeline stages, where different geometric representations become available as various computational operations are performed on the captured data.

In some implementations, different types of progressive visualization approaches may be combined to create more sophisticated and informative feedback presentations. The system may initially visualize a grayscale point cloud in the sequence in which the scan was captured, providing users with a temporal representation of the data acquisition process. In some cases, the system may then visualize a colorized wireframe on top of the previously visualized grayscale point cloud, creating a layered visualization that shows both the original data capture progression and the enhanced geometric understanding. Next, the system may present a textured mesh over or replacing the colorized wireframe.

In some examples, the physical environment may include multiple floors. In these examples, the system may encounter significant visual overlap between different floor levels that can create confusion and reduce the clarity of the visualization. To address this challenge, the system may display only a single floor at any given time, potentially eliminating visual clutter and providing users with a clear, unobstructed view of each floor level. In other implementations, the system may extract floor information from the visualization mesh. For example, the system may utilize the trajectory, based at least in part on a sequence of viewpoint bundle root frame positions, to divide a scan into floors. For example, the system may utilize clustering techniques, such as K-means clustering applied to Y coordinate data in which the clustering algorithm may employ dynamic K values and cluster merging operations to automatically determine the appropriate number of floors and their boundaries within the scanned environment.

In some aspects, once floor assignments have been determined, the viewpoint bundles may be sorted using a hierarchical criteria system. The floor assignment may serve as a primary sorting criteria and the scanning order may serve as the secondary criteria for organizing viewpoint bundles within each floor. In some examples, the viewpoint bundle meshes of each floor may be merged into a single comprehensive mesh. During the merging process, the system may record start and end indices for each viewpoint bundle mesh along with their corresponding floor assignments.

In some implementations, the system may provide user interface elements and real-time feedback mechanisms to enhance user engagement and understanding during the processing operations. The user interface may include various progress indicators and status displays that inform users about the current state and expected completion time of the 3D model generation process.

In some aspects, the system may notify users about status updates associated with 3D model generation, including when processing has finished, through various communication channels. These notifications may include push notifications, in-app notifications, email messages, text messages, audible alerts, haptic feedback such as vibration, or other suitable notification methods depending on user preferences and device capabilities.

In some implementations, the system may include progress bar indicators to provide users with information about processing status and completion estimates. In some cases, the progress bar indicators may represent lapsed, remaining, and total processing time may be displayed to users during the 3D model generation process. In some cases, postprocess code may report its progress to the visualization part on completion of the post-process stages and inside stages where applicable. The visualization part may take into account reports, estimate progress speed, and extrapolate progress bar updates in real-time, correcting those estimations upon new progress reports, and/or the like.

In some aspects, steps and status of the processing may be displayed to the user through text and graphics. Examples of statuses may include “Step 1 of 3: Computing geometry . . . ”, “Step 2 of 3: Improving accuracy . . . ”, and “Step 3 of 3: Adding color . . . ”. In some implementations, the statuses may be triggered by reaching certain milestones during processing, such as “geometry computation finished”, processing completion percentages, such as “30% of processing finished”, or time intervals, such as “15 seconds have passed”. The user may be notified about status updates, including when processing has finished, through various communication channels such as push notifications, in-app notifications, email, text messages, sound, vibration, or other suitable notification methods.

In some cases, progress may be displayed using various formats such as progress bars, percentages, or other visual indicators. Irregular updates on progress percentage status may create jarring jumps in the display. Instead of using the last progress percentage value directly, the progress indication may employ a smoothing method. In some implementations, the speed of progress may be constantly re-evaluated by calculating a ratio of progress completed and elapsed time. The shown progress may become the value of the last synchronized progress value increased by the estimated progress since the estimated speed may be multiplied by the elapsed time. This smoothing approach may provide users with a more consistent and visually pleasing progress indication throughout the processing operations.

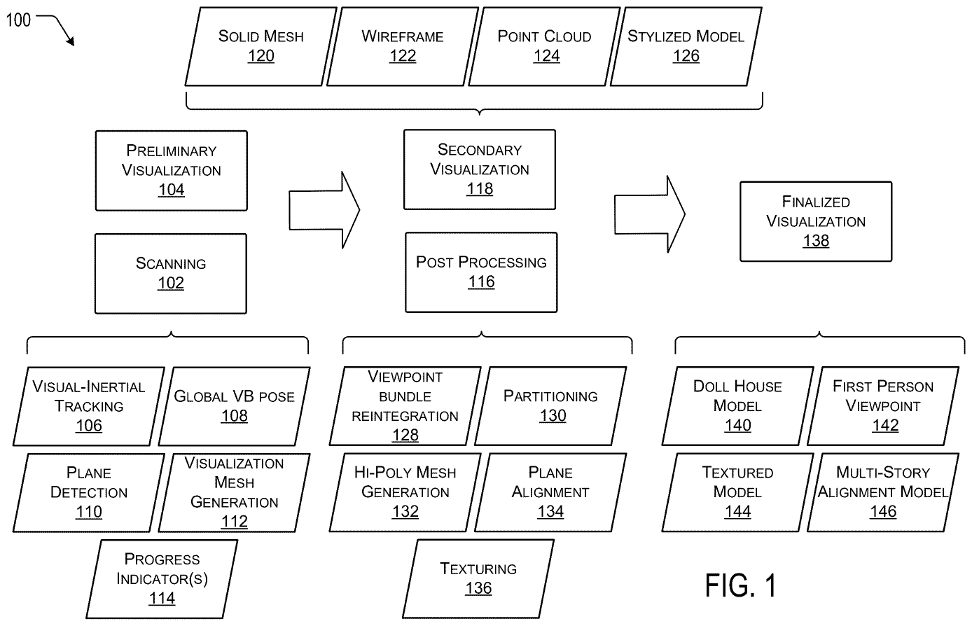

FIG. 1 is an example block diagram of a system 100 for processing three-dimensional scans and generating progress visualizations according to some implementations. As discussed herein, the system 100 may be configured to process captured sensor data from physical environments and objects to generate 3D models and visualizations while providing substantially real-time visual feedback to users during the processing operations. In some cases, the system 100 may be configured to generate preliminary visualizations 104 during scanning 102 and secondary visualizations 118 during post-processing 116 to maintain user engagement and provide informative progress feedback prior to generation of the finalized visualization 138.

In the current example, the system 100 may initiate with scanning 102 where sensor data is captured from a physical environment using devices equipped with depth sensors, cameras, inertial measurement units, and/or the like. During scanning 102, operations associated with generating preliminary visualizations 104 may be performed to provide a user with feedback to assist the user in understanding the current status of the scanned data and of the processing towards the finalized visualizations 138.

In some implementations, during scanning operations or sessions 102, the system 100 may perform various operations to generate the preliminary visualizations 104. For example, the visual-inertial tracking system 106 may process camera or image device data (e.g., frames and/or video data) and inertial measurement unit data (e.g., position and orientation data) to estimate frame poses of the capture device. In this manner, the visual-inertial tracking system 106 may provide spatial positioning information for each captured frame. The global viewpoint bundle system 108 may accumulate and organize data from consecutive frames with similar environment positions (e.g., within one or more thresholds) into viewpoint bundles. In some cases, the plane detection system 110 may operate to extract three-dimensional planes from captured geometries within completed viewpoint bundles, identifying structural surfaces such as walls, ceilings, floors, and other planar elements in the physical environment. The visualization mesh generation system 112 may convert the processed viewpoint bundle data into mesh representations that can be rendered and displayed to user during the scanning session or operation 102 as the preliminary visualization 104. In some aspects, the progress indicator system 114 may monitor the status of these various processing operations and provide substantially real-time feedback to users regarding the current progress and completion status of the scanning operation 102 as well as the overall model generation. For instance, the progress indicator system 114 may provide feedback associated with data quality, scan coverage completeness, current processes or operations, estimated time remaining for processing operations, and/or the like.

In some cases, the system 100 may align or overlay the preliminary visualization 104 over the camera or image device feed to assist the user in identifying and scanning additional portions of the physical environment. This overlay approach may enable users to observe both the live camera view and the evolving 3D model simultaneously, providing immediate visual feedback about which areas have been successfully captured and which regions may require additional scanning coverage. In some implementations, the overlay visualization may be rendered as a semitransparent mesh or wireframe representation that allows the underlying camera feed to remain visible while highlighting the reconstructed geometry. In some aspects, the system may utilize the estimated frame poses from the visual-inertial tracking system 106 to ensure proper alignment between the preliminary visualization 104 and the live camera view, maintaining spatial coherence as the user moves through the physical environment. In some examples, the overlay may incorporate color coding or visual indicators to distinguish between well-scanned areas with high data quality and regions that may benefit from additional data capture, potentially guiding users toward areas that require more thorough scanning to improve the final model quality.

In some implementations, once scanning is complete, the system 100 may transition to post-processing 116 operations. In some cases, it should be understood that post processing 116 may be performed on a portion of the viewpoint bundles while scanning operation 102 are still being carried out by the user. In some examples, the post processing operation 116 may be used to refine and enhance the captured data for generation of the finalized visualization 138. During post-processing 116, the system 100 may present secondary visualizations 118 as each secondary visualization 118 becomes available to maintain user engagement and provide substantially continuous feedback regarding the finalized visualization 138 generation.

In some aspects, the post-processing 116 may include viewpoint bundle reintegration system 128. During viewpoint bundle reintegration 128 reintegration of viewpoint bundle voxel data using the latest optimized viewpoint bundle poses determined during the scanning 102. This reintegration process may help ensure that the accumulated depth information accurately reflects the refined spatial positioning and correct for geometric distortions and drift that may have accumulated during data capture operations.

In some implementations, the partitioning system 130 may subdivide the entire scanning volume into manageable partitions to accommodate available computational resources (such as of the device or available via cloud-processing). For instance, the partition size may be dynamically determined based on available system resources, the complexity of the scanned geometry, and the desired balance between processing efficiency and memory utilization. In some cases, this partitioning approach may enable the system to handle large-scale environments that might otherwise exceed available computational resources.

In some examples, the hi-poly mesh generation system 132 may construct high-resolution meshes for each individual partition created by the partitioning system 130. The hi-poly mesh generation system 132 may then merge these individual partition meshes into a comprehensive final high-polygon mesh. In some aspects, the merging process may include alignment and blending operations to ensure seamless transitions between adjacent partitions while maintaining geometric continuity across the entire scanned environment.

In some cases, the plane alignment system 134 may perform plane detection operations on the merged mesh and align vertices belonging to the same detected plane. This alignment process may improve the visual quality of large flat surfaces such as walls, floors, ceilings, and/or other planar or flat surfaces by reducing visual noise and creating cleaner geometric representations. In some implementations, the plane alignment system 134 may utilize previously detected plane information from the scanning phase 102, potentially refining and extending those results with the complete dataset.

In some aspects, the texturing system 136 may select keyframes from the captured image data based on factors such as data redundancy, visual area overlap, image quality, viewing angle, and lighting conditions. The texturing system 136 may generate texture patches from the selected keyframes and merge these patches into texture atlases. In some implementations, the texture atlas generation process may involve seam minimization and color blending operations to create cohesive texture representations that accurately reflect the visual appearance of the scanned environment.

In some examples, during post-processing 116, the system 100 may generate various types of secondary visualizations 118 to provide users with different perspectives and levels of detail regarding the processing progress. The solid mesh visualization 120 may present the evolving model as a complete surface representation allowing users to observe the development of the final geometric structure. In some cases, the wireframe visualization 122 may display the mesh connectivity and edge relationships, providing insight into the underlying geometric framework of the model. The point cloud visualization 124 may show the raw or processed point data, potentially with color coding to indicate processing status or data quality. In some implementations, the stylized model visualization 126 may present the data using various artistic or simplified representations, such as voxelized displays, sketch-like renderings, or other visual styles that may enhance user engagement during the processing operations.

In some aspects, upon completion of post-processing 116, the system 100 may generate the finalized visualization 138 which may include various presentation formats and viewing modes. The doll house model generation and visualization 140 may provide users with a comprehensive three-dimensional overview of the entire scanned environment, potentially allowing for interactive exploration and examination of the reconstructed space. In some cases, the first person viewpoint generation and visualization 142 may enable users to navigate through the scanned environment from an immersive first-person perspective, simulating the experience of walking through the physical space. The textured model generation and visualization 144 may apply the texture information generated by the texturing system 136 to create photorealistic representations of the scanned environment. In some implementations, the multi-story generation and visualization 146 may handle environments with multiple floor levels, organizing and presenting the floor information in a clear and structured manner that allows users to navigate between different levels of the scanned space.

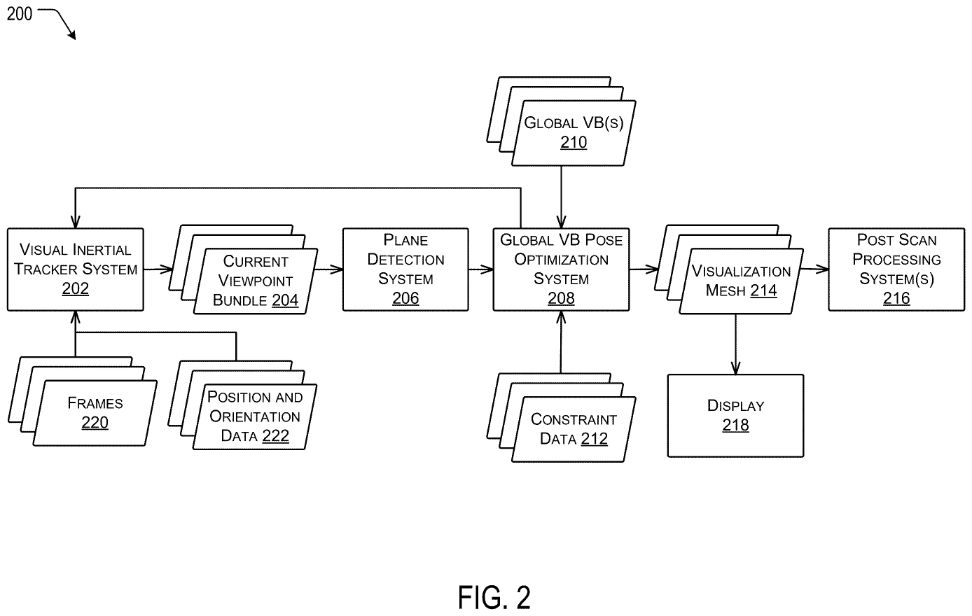

FIG. 2 is an example block diagram of a device or system associated with scanning operations 200 performed during a scanning session and for processing three-dimensional scans during scanning operations according to some implementations. As discussed herein, the device may be configured to process captured sensor data in substantially real-time during scanning sessions to generate preliminary visualizations and provide immediate feedback to users. In some cases, the device may be configured to perform visual-inertial tracking, viewpoint bundle management, plane detection, and pose optimization operations during active scanning to enable real-time visualization and user guidance.

In the current example, a user may initiate a scanning session 200 on a device. During the scanning session 200 sensor data including frames 220 (e.g., image data, video data, lidar data, depth data, and/or the like) and position and orientation data (e.g., IMU data) of a physical environment is actively captured. In some implementations, during the scanning session 200, the device may perform various real-time processing operations to generate visual feedback for the user. For example, the device may include a visual inertial tracking system 202 that may process the incoming frames 220 and position and orientation data 222 to estimate frame poses of the capture device. In this manner, the visual inertial tracking system 202 may provide spatial positioning information for each captured frame as the scanning progresses. The visual inertial tracking system 202 may accumulate and organize the sensor data from consecutive frames with similar physical positions into a single active or current viewpoint bundle 204.

In some cases, the plane detection system 206 may operate on completed viewpoint bundles to extract three-dimensional planes from captured geometries, identifying structural surfaces such as walls, ceilings, floors, sides of objects, and other planar or flat features in the physical environment. The plane detection system 206 may process viewpoint bundle data 204 in the background while scanning operations 200 continue, thereby enabling the device and/or system to generate geometric visualizations and understanding of the physical environment without interrupting the data capture process.

In some aspects, the device may include a global viewpoint bundle pose optimization system 208 that may receive input from both the plane detection system 206 as well as global viewpoint bundle(s) 210 which, for example, may contain accumulated data from previously processed viewpoint bundles. The global viewpoint bundle pose optimization system 208 may utilize constraint data 212 (e.g., various geometric and spatial constraints, such as flat plane constraints, Manhattan world constraints, room overlap constraints, distance thresholds, co-planarity constraints, structural integrity constraints, and/or the like) to refine viewpoint bundle poses and improve geometric consistency across the models and visualizations.

In some cases, when one or more thresholds are met or exceeded, the system or device may return to the visual inertial tracking system 202 and begin processing a new viewpoint bundle, as discussed herein. In some implementations, these thresholds may include pose difference criteria where the spatial displacement between the first frame of the current viewpoint bundle 204 and a newly arrived frame exceeds predetermined distance or angular limits in one or more of the six degrees of freedom. In some aspects, the thresholds may encompass temporal criteria, such as when a specified time duration has elapsed since the initiation of the current viewpoint bundle 204, or when a maximum number of frames have been accumulated within the bundle. In some examples, the thresholds may include data volume criteria, where the total amount of sensor data associated with the current viewpoint bundle 204 reaches a predetermined storage or processing capacity limit.

In some cases, the optimized viewpoint bundle data may be utilized to generate one or more visualization mesh(es) 214. The visualization mesh 214 may be presented on the display 218 to provide users with visual feedback during the scanning session 200. In some implementations, the display 218 may render the visualization mesh 214 as an overlay on the live camera feed allowing users to observe both the physical environment and the evolving three-dimensional model simultaneously. In some aspects, the visualization mesh 214 may be presented using various rendering techniques, such as wireframe representations, solid mesh displays, or point cloud visualizations, depending on the current processing stage and user preferences.

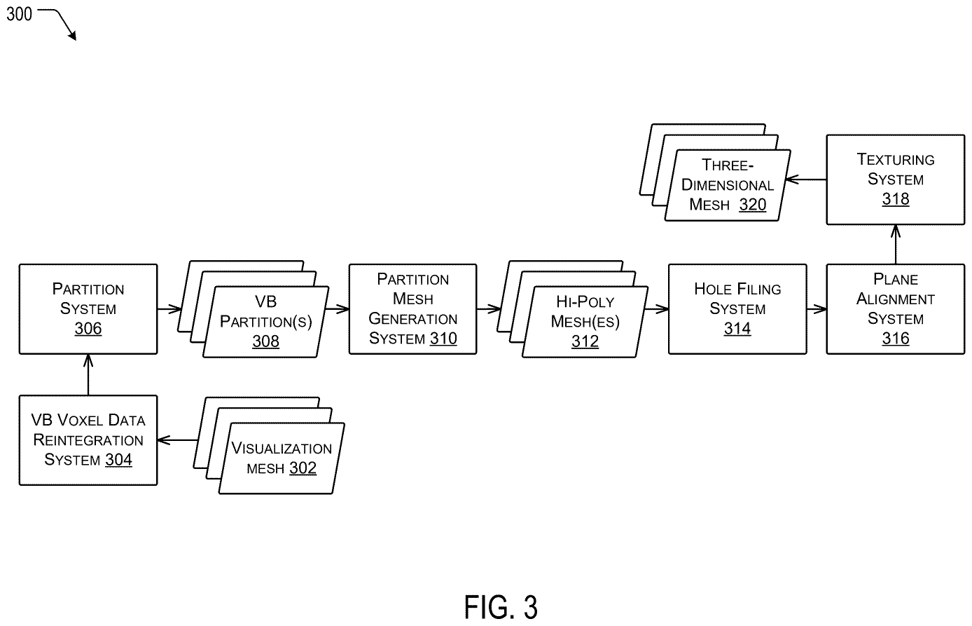

In some cases, the visualization mesh 214 may also be provided to the post scan processing system(s) 216 for further refinement and enhancement operations. The post scan processing system(s) 216 may receive the visualization mesh 214 data and perform additional processing operations to generate higher quality three-dimensional models and visualizations. In some implementations, the post scan processing system(s) 216 may include various subsystems and components that operate on the visualization mesh 214 data to produce finalized three-dimensional representations of the scanned environment. In some aspects, the post scan processing system(s) 216 may be discussed in more detail with respect to FIG. 3.

FIG. 3 is an example block diagram of post processing operations 300 for processing three-dimensional scans according to some implementations. As discussed herein, the post processing operations 300 may be configured to refine and enhance captured sensor data to generate high-quality finalized three-dimensional models and visualizations. In some cases, the post processing operations 300 may be configured to perform viewpoint bundle reintegration, partitioning, mesh generation, hole filling, plane alignment, and texturing operations to produce comprehensive three-dimensional representations of scanned environments.

In the current example, the post processing operations 300 may receive a visualization mesh 302 generated during the scanning session. In some implementations, during the post processing operations 300, the system may perform various operations to improve the quality and completeness of resulting three-dimensional models and/or visualizations 320. For example, the system may include a VB voxel data reintegration system 304 that may process the visualization mesh 302 to reintegrate viewpoint bundle voxel data with the latest optimized viewpoint bundle poses. In this manner, the VB voxel data reintegration system 304 may ensure that accumulated depth information accurately reflects refined spatial positioning and corrects for geometric distortions and accumulated drift that may have occurred during data capture operations.

In some cases, the partition system 306 may operate on the reintegrated data to subdivide the entire scanning volume into manageable partitions for processing. The partition system 306 may generate VB partition(s) 308 that represent discrete spatial regions of the scanned environment, enabling the system to handle large-scale environments while accommodating computational resource constraints. The partition system 306 may process the reintegrated voxel data in a systematic manner, thereby enabling the device and/or system to manage memory utilization and processing efficiency without compromising geometric accuracy.

In some aspects, the system may include a partition mesh generation system 310 that may receive input from the VB partition(s) 308 to construct high-resolution meshes for individual partitions. The partition mesh generation system 310 may generate hi-poly mesh(es) 312 that represent detailed geometric representations of the partitioned regions. The partition mesh generation system 310 may utilize various mesh generation algorithms and techniques to create comprehensive surface representations that maintain geometric continuity across partition boundaries.

In some cases, when partition processing is complete, the system may proceed to the hole filling system 314 which may process the hi-poly mesh(es) 312 to address gaps and missing areas in the mesh. In some implementations, the hole filling system 314 may utilize geometry interpolation techniques, surface reconstruction algorithms, or patch-based completion methods to fill unscanned regions or areas with insufficient sensor data. In some aspects, the hole filling system 314 may consider surrounding surface characteristics and geometric patterns to generate visually coherent completions that maintain the overall quality of the three-dimensional model.

In some examples, the hole filling system 314 may provide processed mesh data to the plane alignment system 316, which may perform plane detection operations and align vertices belonging to the same detected plane. The plane alignment system 316 may improve the visual quality of large flat surfaces by reducing visual noise and creating cleaner geometric representations of walls, floors, ceilings, and other planar surfaces within the scanned environment. In some implementations, the hole filling system 314 may employ various computational techniques to address gaps in the mesh or visualization data. For example, the hole filling system 314 may utilize Poisson surface reconstruction, radial basis function (RBF) interpolation, Delaunay triangulation algorithms, and/or the like.

In some cases, the plane alignment system 316 may provide refined mesh data to the texturing system 318 which may select keyframes and generate texture patches for the three-dimensional model. The texturing system 318 may merge texture patches into texture atlases and apply color and visual information to create photorealistic representations of the scanned environment. In some implementations, the texturing system 318 may produce a three-dimensional mesh 320 as the final output, representing the completed three-dimensional model with applied textures, geometric refinements, and enhanced visual quality suitable for various visualization and application purposes.

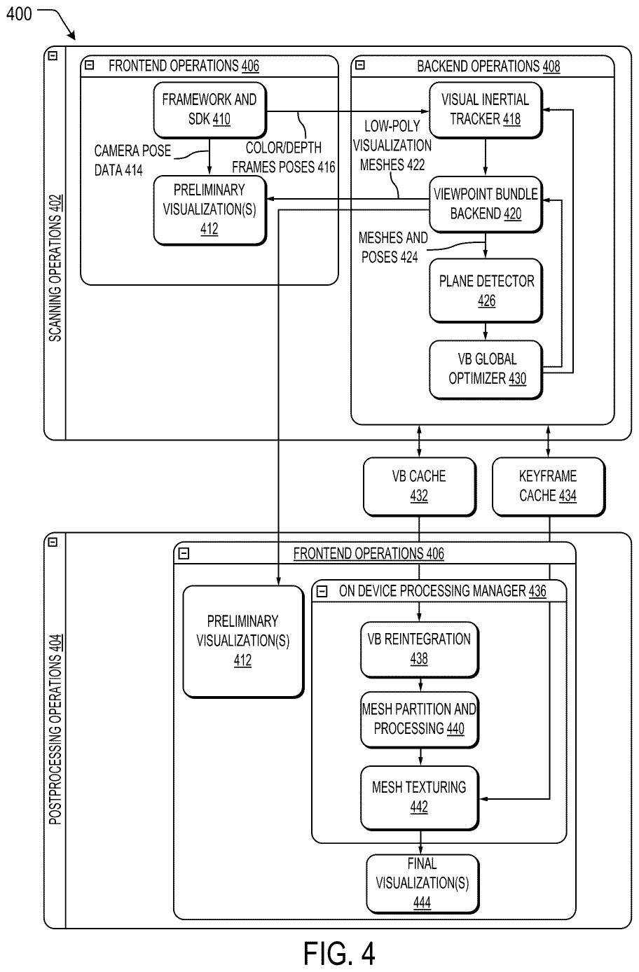

FIG. 4 is an example block diagram of a device 400 for processing three-dimensional scans according to some implementations. As discussed herein, the device 400 may be configured to process captured sensor data (e.g., frame and IMU data) during scanning sessions and perform subsequent refinement operations to generate finalized three-dimensional models and visualizations. In some cases, the device 400 may be configured to operate within a frontend operations 406 that provides comprehensive scanning and processing capabilities on mobile or portable devices.

In the current example, the device 400 may include scanning operations 402 and post processing operations 404. During scanning operations 402, the device 400 may utilize framework and software development kit (SDK) 410 to receive camera pose data 414 and generate color/depth frames poses 416. In some implementations, SDK 410 may provide foundational tracking and pose estimation capabilities that serve as input for more advanced processing operations. The color/depth frames poses 416 may be provided to preliminary visualization(s) 412, which may present initial visual feedback to users during the scanning session.

In some aspects, the scanning operations 402 may include backend operations 408 such as simultaneous localization and mapping (SLAM) operations, which may receive input from the color/depth frames poses 416 generated by SDK 410. The backend operations 408 may include a visual inertial tracker 418 that may process the color/depth frames poses 416 to estimate frame poses of the capture device with enhanced accuracy and robustness compared to basic tracking systems. In some cases, the visual inertial tracker 418 may provide output to a viewpoint bundle backend 420, which may accumulate and organize data from consecutive frames with similar positions into coherent data structures.

In some implementations, the viewpoint bundle backend 420 may generate low-poly visualization meshes 422 that may be provided to the preliminary visualization(s) 412 for display to users during scanning operations 402. The low-poly visualization meshes 422 may provide real-time visual feedback while maintaining computational efficiency suitable for mobile device processing capabilities. In some examples, the viewpoint bundle backend 420 may also generate meshes and poses 424, which may be provided to a plane detector 426 for geometric analysis operations.

In some cases, the plane detector 426 may operate to extract three-dimensional planes from the captured geometries within completed viewpoint bundles. The plane detector 426 may identify structural surfaces such as walls, ceilings, floors, and other planar elements within the scanned environment. In some aspects, the plane detector 426 may provide output to a VB global optimizer 430, which may perform pose optimization operations using constraint data to refine viewpoint bundle poses and improve geometric consistency across the evolving three-dimensional model.

In some implementations, the VB global optimizer 430 may receive input from and provide output to both a VB cache 432 and a keyframe cache 434. The VB cache 432 may store viewpoint bundle data for subsequent processing operations, while the keyframe cache 434 may store selected frames for texturing operations. In some examples, the VB global optimizer 430 may provide optimized data back to the viewpoint bundle backend 420 and to the backend operations s 408 for use in generating updated visualizations and maintaining tracking accuracy throughout extended scanning sessions.

In some aspects, during post processing operations 404, the frontend operations 406 may include an on device processing manager 436 that may coordinate various refinement operations. The on device processing manager 436 may receive input from the preliminary visualization(s) 412 and manage the processing pipeline for generating finalized three-dimensional models. In some cases, the on device processing manager 436 may include VB reintegration 438, which may reintegrate viewpoint bundle voxel data with optimized viewpoint bundle poses to ensure geometric accuracy in the final model.

In some implementations, the VB reintegration 438 may provide output to mesh partition and processing 440, which may subdivide the scanning volume into manageable partitions and construct high-resolution meshes for individual partitions. The mesh partition and processing 440 may enable the device 400 to handle large-scale environments while accommodating memory and processing constraints of mobile devices. In some examples, the mesh partition and processing 440 may provide processed mesh data to mesh texturing 442, which may receive additional input from the keyframe cache 434.

In some cases, the mesh texturing 442 may select keyframes and generate texture patches that may be merged into texture atlases for the three-dimensional model. The mesh texturing 442 may apply color and visual information to create photorealistic representations of the scanned environment. In some aspects, the mesh texturing 442 may generate final visualization(s) 444, which may represent the completed three-dimensional model with applied textures and geometric refinements suitable for various visualization and application purposes.

In some implementations, the device 400 may maintain data flow connections between the VB cache 432, keyframe cache 434, and the various processing components to enable efficient processing and visualization generation throughout both scanning operations 402 and post processing operations 404. The integrated architecture may allow for seamless transitions between real-time scanning feedback and comprehensive post-processing refinement operations within a single application framework.

In the current example, the terms frontend and backend are utilized to describe operations of the system. It should be understood, that both the backend and frontend operations may be performed on the device, in the cloud, and/or a combination thereof. For example, in the illustrated example above, the frontend operation 406 and the backend operations 408 are all preformed on the capture device 400.

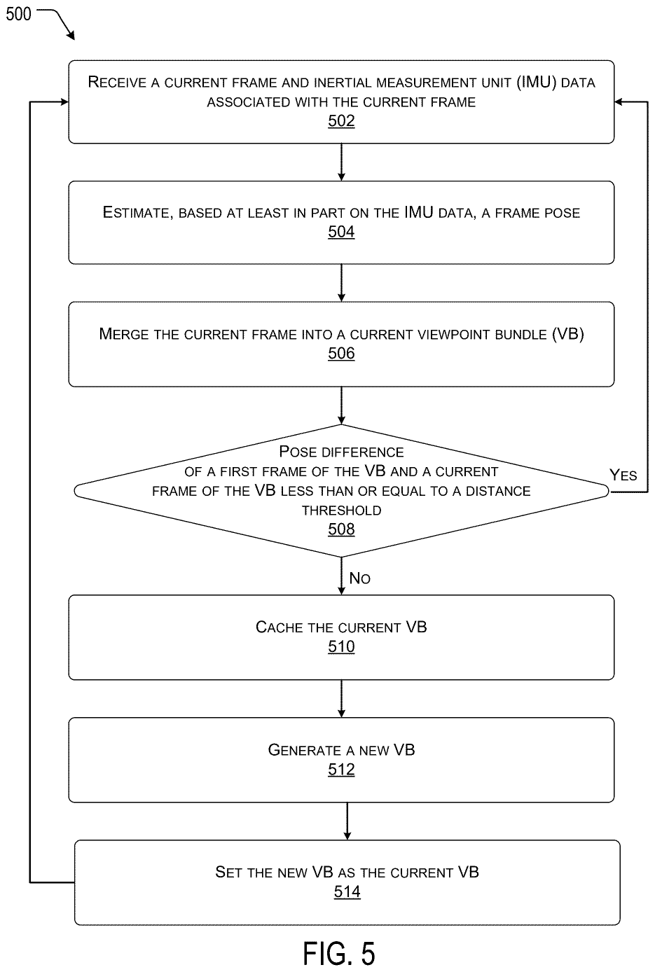

FIGS. 5-10 are flow diagrams illustrating example processes associated with the model generation operation associated with a physical environment discussed herein. The processes are illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, when executed by one or more processor(s), performs the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 5 is a flow diagram illustrating an example process 500 for managing viewpoint bundles during three-dimensional scanning operations, according to some implementations. The process 500 may be performed by the three-dimensional scanning system to organize captured sensor data into discrete viewpoint bundles based on spatial proximity criteria, enabling efficient processing and management of scan data during active scanning sessions.

At 502, the system may receive a current frame and IMU data associated with the current frame. In some cases, the current frame may include image data, depth data, lidar data, or other sensor information captured by a scanning device during a three-dimensional scanning session. The IMU data may provide position and orientation information corresponding to the capture device's spatial state at the time the current frame was acquired, enabling the system to track device movement and establish spatial relationships between consecutive frames.

At 504, the system may estimate a frame pose based at least in part on the IMU data. The frame pose estimation may utilize visual-inertial tracking techniques that combine the IMU data with visual information from the current frame to determine the spatial position and orientation of the capture device. In some implementations, the system may employ SLAM techniques, extended Kalman filters, or other tracking methodologies to generate accurate pose estimates that account for device movement through the physical environment.

At 506, the system may merge the current frame into a current viewpoint bundle. The merging operation may involve accumulating the current frame's sensor data, including depth information, image data, and associated pose information, into the active viewpoint bundle data structure. In some aspects, the viewpoint bundle may serve as a consolidated storage mechanism for sequences of frames captured from similar spatial positions, enabling efficient organization and processing of related sensor data.

At 508, the system may determine whether a pose difference between a first frame of the viewpoint bundle and the current frame of the viewpoint bundle is less than or equal to a distance threshold. This determination may involve calculating spatial displacement and angular differences across one or more degrees of freedom between the initial frame pose of the viewpoint bundle and the pose of the currently processed frame. In some implementations, the distance threshold may be configurable based on factors such as scanning environment characteristics, desired model resolution, available computational resources, or quality requirements for the three-dimensional reconstruction. If the pose difference is less than or equal to the distance threshold, the process 500 may return to 502 to continue receiving additional frames and accumulating sensor data into the current viewpoint bundle. This iterative accumulation may allow the system to build comprehensive viewpoint bundles that captures sufficient geometric information from similar spatial perspectives while maintaining computational efficiency. However, if the pose difference exceeds the distance threshold, the process 500 may proceed to 510, where the system may cache the current viewpoint bundle. The caching operation may involve storing the completed viewpoint bundle data for subsequent processing operations, including plane detection, pose optimization, and mesh generation. In some aspects, the cached viewpoint bundle may be processed in parallel with ongoing scanning operations to maintain performance and user feedback capabilities.

At 512, the system may generate a new viewpoint bundle to begin accumulating subsequent frame data. The new viewpoint bundle creation may establish a fresh data structure for organizing sensor information captured from the next spatial region or viewing perspective encountered during the scanning session. In some implementations, the system may initialize the new viewpoint bundle with appropriate data structures and processing parameters to ensure consistent handling of incoming sensor data.

At 514, the system may set the new viewpoint bundle as the current viewpoint. This assignment operation may designate the newly created viewpoint bundle as the active data structure for receiving and organizing subsequent frame data. Following this assignment, the process 500 may return to 502 to continue the scanning session with the newly established current viewpoint bundle, enabling continuous data capture and organization throughout extended scanning operations.

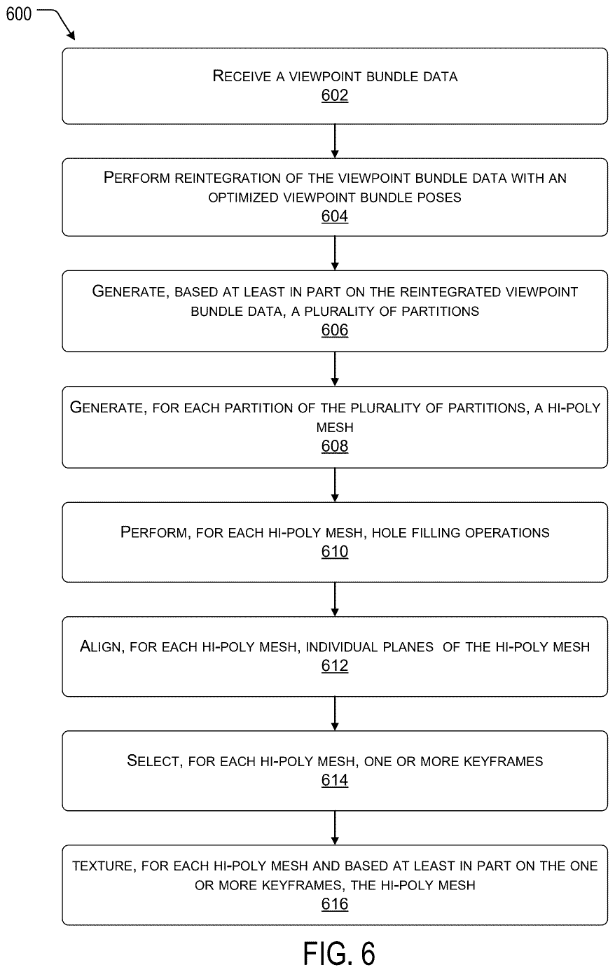

FIG. 6 is a flow diagram illustrating an example process 600 for generating and texturing high-polygon meshes during post-processing operations, according to some implementations. The process 600 may be performed by the three-dimensional scanning system to refine captured viewpoint bundle data and generate finalized textured three-dimensional models with enhanced geometric accuracy and visual quality.

At 602, the system may receive viewpoint bundle data from completed scanning operations. In some cases, the viewpoint bundle data may include accumulated sensor information, depth data, image frames, and associated pose information that has been organized and cached during the scanning session. The viewpoint bundle data may represent discrete spatial regions or viewing perspectives of the scanned environment that have been processed through initial pose estimation and plane detection operations.

At 604, the system may perform reintegration of the viewpoint bundle data with optimized viewpoint bundle poses. The reintegration operation may utilize the latest pose optimization results to ensure that accumulated depth information accurately reflects refined spatial positioning determined during global pose optimization processes. In some implementations, the reintegration may correct geometric distortions and cumulative drift errors that may have occurred during the scanning phase, potentially improving the overall accuracy of the depth data before subsequent processing operations.

At 606, the system may generate a plurality of partitions based at least in part on the reintegrated viewpoint bundle data. The partitioning operation may subdivide the entire scanning volume into manageable spatial regions to accommodate available computational resources, including memory, processing power, and storage capacity of the processing device. In some aspects, the partition size may be dynamically determined based on factors such as available system resources, the complexity of the scanned geometry, or the desired balance between processing speed and memory utilization.

At 608, the system may generate a high-polygon mesh for each partition of the plurality of partitions. The mesh generation process may construct detailed geometric representations for individual partitioned regions, utilizing various mesh generation algorithms and techniques to create comprehensive surface representations. In some implementations, the system may process multiple partitions in parallel to accelerate overall processing time while maintaining geometric continuity across partition boundaries.

At 610, the system may perform hole filling operations for each high-polygon mesh. The hole filling process may address gaps and missing areas in the mesh that may result from unscanned regions of the physical environment or areas with insufficient sensor data. In some cases, the hole filling operations may employ various computational geometry techniques, such as Poisson surface reconstruction, radial basis function interpolation, or patch-based completion methods to generate plausible surface geometry in areas where sensor data may be incomplete or unavailable.

At 612, the system may align individual planes of the high-polygon mesh for each high-polygon mesh. The plane alignment process may perform plane detection operations on the mesh data and align vertices belonging to the same detected plane to improve visual quality and reduce noise on large flat surfaces. In some aspects, the plane alignment may help create cleaner, more geometrically accurate representations of architectural surfaces such as walls, floors, and ceilings within the scanned environment.

At 614, the system may select one or more keyframes for each high-polygon mesh. The keyframe selection process may identify frames that provide optimal texture information for the three-dimensional model based on factors such as data redundancy, visual area overlap, image quality, viewing angle, lighting conditions, and spatial coverage. In some implementations, the keyframe selection algorithm may help speed up texturing operations by selecting a reasonable subset of the most valuable frames from the total frame count captured during scanning.

At 616, the system may texture each high-polygon mesh based at least in part on the one or more selected keyframes. The texturing operation may generate texture patches from the selected keyframes and merge these patches into texture atlases for the three-dimensional model. In some cases, the texture atlas generation process may involve seam minimization and color blending operations to create cohesive texture representations that accurately reflect the visual appearance of the scanned environment, resulting in photorealistic three-dimensional models suitable for various visualization and application purposes.

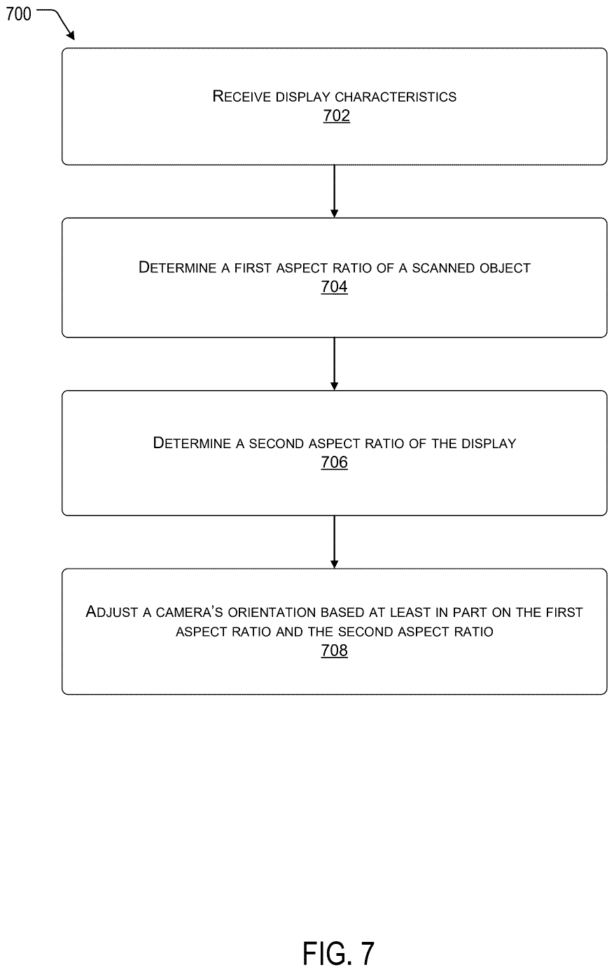

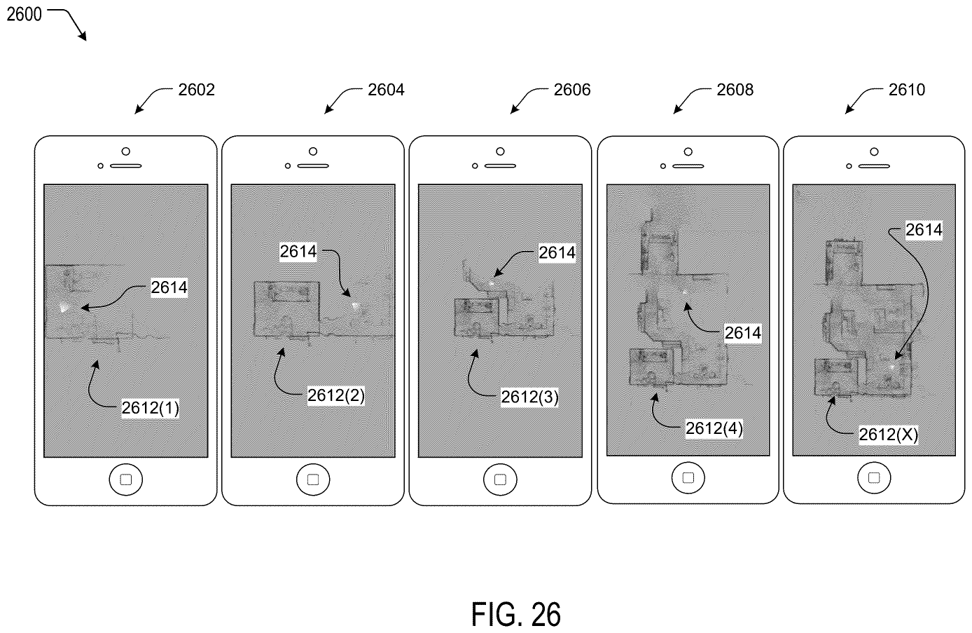

FIG. 7 is a flow diagram illustrating an example process 700 for adjusting camera orientation during three-dimensional scanning visualization and progress bar or status visualization operations (e.g., such as those illustrated below with respect to FIGS. 26-28), according to some implementations. The process 700 may be performed by the three-dimensional scanning system to optimize viewing experience by dynamically adapting camera perspective based on the relationship between scanned object proportions and display device characteristics.

At 702, the system may receive display characteristics associated with a display device. In some cases, the display characteristics may include information such as screen dimensions, aspect ratio, resolution, pixel density, or other properties of the display device on which the three-dimensional scan visualization will be presented. The display characteristics may be obtained from device specifications, operating system APIs, or user interface frameworks that provide access to display configuration information.

At 704, the system may determine a first aspect ratio of a scanned object based at least in part on the captured three-dimensional data. In some implementations, the first aspect ratio may be calculated based on the dimensions of the scanned object's bounding box, representing the ratio between the width and height of the object's overall spatial extent. The first aspect ratio may provide information about the geometric proportions of the captured three-dimensional data, enabling the system to understand the spatial characteristics of the scanned environment or object.

At 706, the system may determine a second aspect ratio of the display based at least in part on the display characteristics. The second aspect ratio may represent the proportional relationship between the width and height of the display screen on which the visualization will be rendered. In some cases, the second aspect ratio may be derived from the display characteristics received at 702, such as screen resolution or physical dimensions, to establish the viewing area proportions available for presenting the three-dimensional model.

At 708, the system may adjust a camera's orientation based at least in part on the first aspect ratio and the second aspect ratio. The adjustment operation may involve analyzing the relationship between the scanned object's proportions and the display device's screen proportions to optimize the viewing experience and maximize screen area utilization. In some implementations, when the first aspect ratio and the second aspect ratio are mismatched beyond a predetermined threshold, the system may automatically adjust the camera's orientation by swapping coordinate axes, such as the x-axis and z-axis, or applying rotational transformations to better align the object's primary dimensions with the display's orientation. In some aspects, this adaptive approach may ensure optimal visualization experience regardless of the device used for viewing, providing users with a well-framed representation of the scanned object that efficiently utilizes available display space while maintaining visual clarity and comprehensibility of the three-dimensional model.

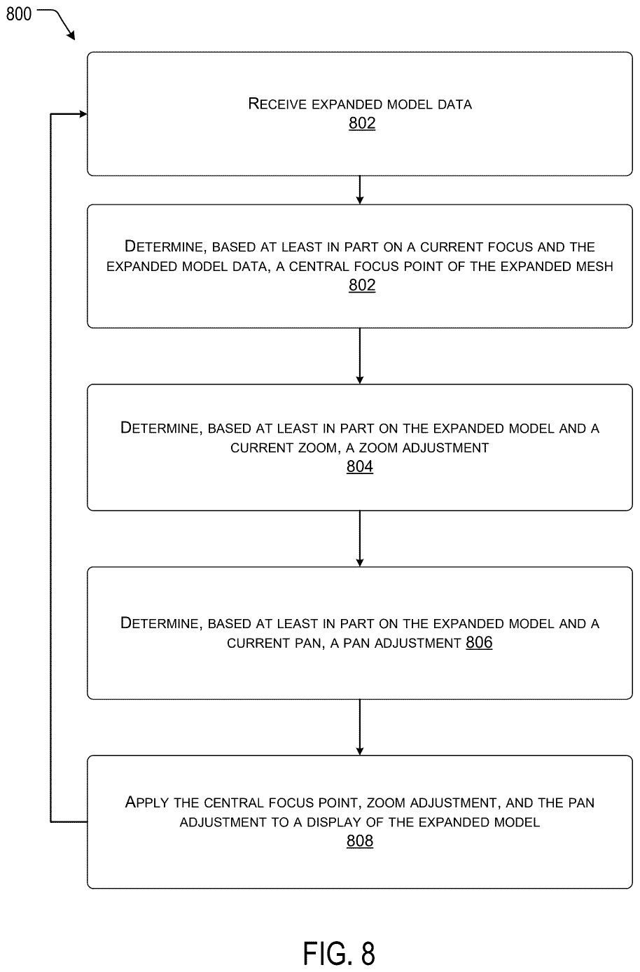

FIG. 8 is a flow diagram illustrating an example process 800 for managing dynamic camera adjustments during three-dimensional scanning visualization operations, according to some implementations. The process 800 may be performed by the three-dimensional scanning system to maintain optimal viewing parameters as the scanned model evolves, ensuring continuous visual feedback and user engagement throughout the reconstruction process.

At 802, the system may receive expanded model data representing the evolving three-dimensional reconstruction. In some cases, the expanded model data may include updated mesh information, additional viewpoint bundle data, or refined geometric representations that reflect the progressive accumulation of sensor data during the scanning session. The expanded model data may continuously grow and change as new data points are captured and integrated into the developing three-dimensional model.

At 804, the system may determine a zoom adjustment based at least in part on the expanded model data and current zoom parameters. The zoom adjustment calculation may be based on the bounding box dimensions of the mesh, which may continuously update as new data points are added to the reconstruction. In some implementations, the system may dynamically scale the view to encompass the evolving bounding box potentially ensuring that the user maintains a comprehensive and unobstructed view of the scanned object throughout the reconstruction process. The zoom adjustment may account for changes in the overall spatial extent of the model, preventing portions of the reconstruction from being obscured or truncated as the scan progresses.

At 806, the system may determine a pan adjustment based at least in part on the expanded model data and current pan parameters. The pan adjustment may involve calculating translational offsets to maintain optimal positioning of the expanded mesh within the viewing area. In some aspects, the pan adjustment may account for shifts in the model's center of mass or spatial distribution as additional geometric data is incorporated, ensuring that the visualization remains properly centered and positioned for optimal user viewing experience.

At 808, the system may apply the zoom adjustment and pan adjustment to the display of the expanded model using smooth interpolation techniques. In some implementations, to ensure a seamless and visually pleasing user experience, transitions in camera position and zoom may be executed with smooth, continuous adjustments. The animation system may predict the state of the scan's bounding box at a point in the future, such as 500 milliseconds later, 1000 milliseconds later, or similar future time intervals. In some cases, the system may then interpolate the camera or imaging device parameters between the current bounding box and the predicted bounding box, resulting in a gradual and unobtrusive shift in perspective as the scan progresses. This interpolation method may minimize abrupt camera movements, potentially providing a more comfortable and immersive viewing experience for the user throughout the reconstruction process. Following the application of the adjustments, the process 800 may return to 802 to continue receiving updated expanded model data, enabling continuous adaptation of the viewing parameters as the three-dimensional reconstruction develops.

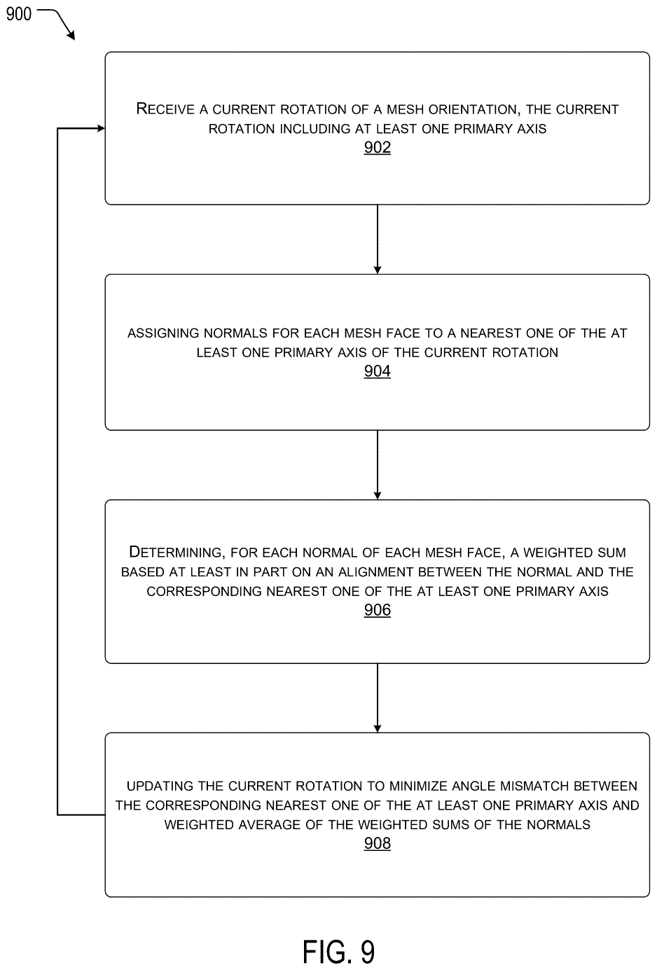

FIG. 9 is a flow diagram illustrating an example process 900 for mesh orientation alignment during three-dimensional scanning visualization operations, according to some implementations. The process 900 may be performed by the three-dimensional scanning system to optimize mesh orientation by aligning primary surfaces with display coordinate axes, providing users with more intuitive and standardized viewing experiences.

At 902, the system may receive a current rotation estimate for the mesh orientation. In some cases, the current rotation estimate may include primary axes (X, Y, Z) that serve as reference directions for the orientation optimization process. The current rotation estimate may be initialized based on an initial guess or may represent an iterative refinement from previous optimization steps.

At 904, the system may assign each mesh face's normal vector to the nearest primary axis of the current rotation estimate. In some implementations, the assignment process may involve calculating angular distances between each face normal and the primary axes, selecting the axis with the smallest angular separation for each face. This assignment operation may establish correspondence between the mesh geometry and the coordinate system axes, enabling subsequent optimization calculations.

At 906, the system may calculate a weighted sum of assigned normals to each axis. In some aspects, the weight for each normal may take into account factors such as the face area and the angle between the normal and the axis. The face area weighting may ensure that larger surfaces have greater influence on the orientation optimization, while the angular weighting may account for the alignment quality between the normal and its assigned axis. In some cases, exact weight calculation methods may vary depending on the iteration number to ensure robustness and convergence of the optimization process. The weighted sum calculation may provide a consolidated representation of how well the current rotation estimate aligns with the mesh geometry.

At 908, the system may update the current rotation estimate to minimize angle mismatch between its primary axes and the normals'weighted average. In some implementations, the update operation may utilize least-squares optimization techniques to refine the rotation parameters. The optimization process may seek to reduce the overall angular deviation between the coordinate axes and the predominant surface orientations within the mesh. Following the rotation update, the process 900 may return to 904 to perform additional iterations of the orientation refinement. In some aspects, the iterative approach may progressively improve the alignment between the mesh's primary surfaces and the display coordinate system, potentially resulting in more intuitive viewing orientations for users. The process 900 may continue until convergence criteria are met, a predetermined number of iterations is completed, or computational time constraints are reached.

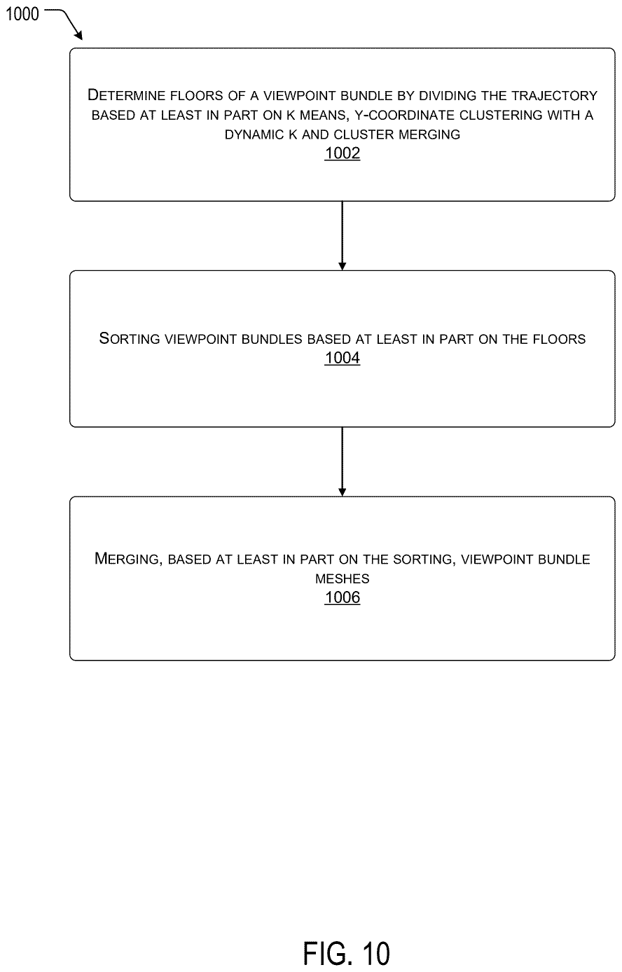

FIG. 10 is a flow diagram illustrating an example process 1000 for determining floors of a viewpoint bundle and merging viewpoint bundle meshes during three-dimensional scanning operations, according to some implementations. The process 1000 may be performed by the three-dimensional scanning system to organize multi-floor environments and generate clear visualizations by separating and processing floor data systematically.

At 1002, the system may determine floors of a viewpoint bundle by dividing the trajectory based at least in part on K means, Y-coordinate clustering with a dynamic K and cluster merging. In some implementations, the trajectory may be defined as a sequence of viewpoint bundle root frame positions that represent the path of the capture device during the scanning session. The K-means clustering algorithm may be applied to the Y-coordinate data, which typically corresponds to the vertical or height dimension in the scanned environment. In some aspects, the dynamic K value may allow the system to determine the appropriate number of floors present in the scanned environment without requiring manual specification. The cluster merging operations may refine the initial clustering results by combining clusters that represent the same floor level, potentially accounting for variations in floor height or scanning patterns that might initially create separate clusters for a single floor.

At 1004, the system may sort viewpoint bundles based at least in part on the floors. In some cases, the sorting operation may utilize a hierarchical criteria system where the floor assignment serves as the primary sorting criterion. In some implementations, the scanning order may serve as a secondary criterion for organizing viewpoint bundles within each floor. This sorting approach may ensure that viewpoint bundles are processed in a logical sequence that reflects both the vertical structure of the environment and the temporal progression of the scanning session.

At 1006, the system may merge viewpoint bundle meshes based at least in part on the sorting. In some aspects, the merging process may combine the individual viewpoint bundle meshes into a single comprehensive mesh representation. During the merging operation, the system may record start and end indices for each viewpoint bundle mesh along with their corresponding floor assignments. In some implementations, this indexing information may enable the system to selectively display or process specific floors or viewpoint bundles as needed for visualization or further processing operations. The merged mesh may provide a unified geometric representation of the scanned environment while maintaining the organizational structure that allows for floor-specific operations and visualizations.

At 1008, the system may apply height-based filtering to dynamically hide geometry outside the currently displayed floor. In some cases, the height-based filtering may utilize the floor assignment information and geometric bounds to selectively render only the portions of the mesh that correspond to the active floor level. The filtering operation may ensure a focused and comprehensible representation of each individual floor by removing visual clutter from other floor levels. In some implementations, the height-based filtering may be dynamically adjusted as users navigate between different floors, providing smooth transitions and maintaining visual clarity throughout the multi-floor visualization experience. The combination of these techniques may enable the visualization to effectively replay the scanning process while presenting each floor level in a clear and organized manner.

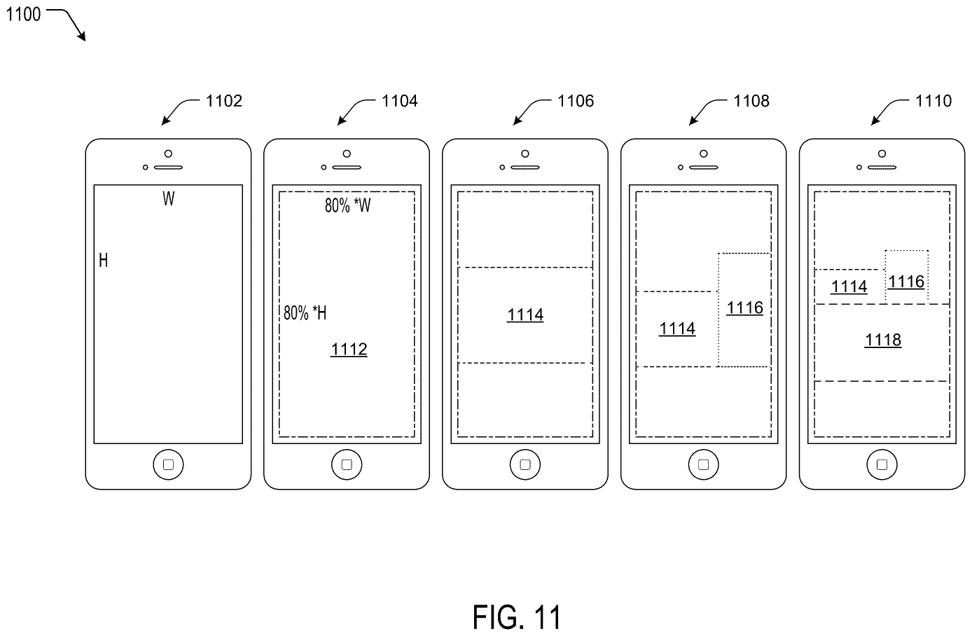

FIG. 11 illustrates visualization and orientation of model feedback during a scanning session 1100 as well as during post processing (which may or may not be performed in parallel to the scanning session 1100) showing the progressive development of preliminary visualizations on a mobile device display, according to some implementations. The visualization operations during a scanning session 1100 may demonstrate how the three-dimensional model evolves and expands as additional sensor data is captured and processed in substantially real-time during the scanning process.

The visualization operations during a scanning session 1100 may include a sequence of display states that show a progression of the three-dimensional reconstruction. In some cases, the first display 1102 may establish the baseline display dimensions, showing width (W) and height (H) parameters (and/or other display characteristics) that define the available screen area for visualization. The display dimensions may serve as reference parameters for subsequent scaling and positioning operations throughout the scanning session.

In some implementations, the second display 1104 may present an initial preliminary visualization 1112 that occupies a portion of the available display area. The preliminary visualization 1112 may be sized to utilize approximately 80% of the display width (80%W) and 80% of the display height (80%H). The sizing approach may ensure that the visualization remains clearly visible while allowing space for user interface elements and controls.

In some aspects, the third display 1106 may show the appearance of a first frame 1114 as part of the three-dimensional model generation. The first frame 1114 may represent initial geometric data captured during the scanning session 1100 providing users with immediate visual feedback about the reconstruction progress. The first frame 1114 may be rendered using various visualization techniques, such as point clouds, wireframe representations, or mesh surfaces, depending on the current processing stage and available data.

In some cases, the fourth display 1108 may demonstrate the progressive accumulation of scan data by presenting both the first frame 1114 and a second frame 1116. The addition of the second frame 1116 may illustrate how the three-dimensional model expands as additional frames are integrated into a viewpoint bundle. The combination of frames may provide users with a growing representation of the scanned environment enabling the user to observe the reconstruction progress in substantially real-time.

In some implementations, the fifth display 1110 may show further expansion of the model by presenting the first frame 1114, second frame 1116, and a third frame 1118. The inclusion of the third frame 1118 may demonstrate continued growth of the three-dimensional reconstruction as more sensor data is captured and processed. The progressive addition of frames may enable users to observe how the scanned environment is being reconstructed incrementally providing continuous feedback about the scanning coverage and model completeness.

In some aspects, the visualization operations during a scanning session 1100 may enable users to assess the quality and completeness of the scan as data is captured. The progressive visualization approach may allow users to identify areas that may require additional scanning coverage or improved data quality before completing the scanning session. In some cases, the real-time feedback provided by the visualization operations may help users make informed decisions about scanning patterns and coverage, potentially improving the overall quality of the final three-dimensional model. In some cases, as each frame is added to the display area the combined frames are centered within the display area and the zoom may be adjusted to provide a smooth transition as each frame is added.

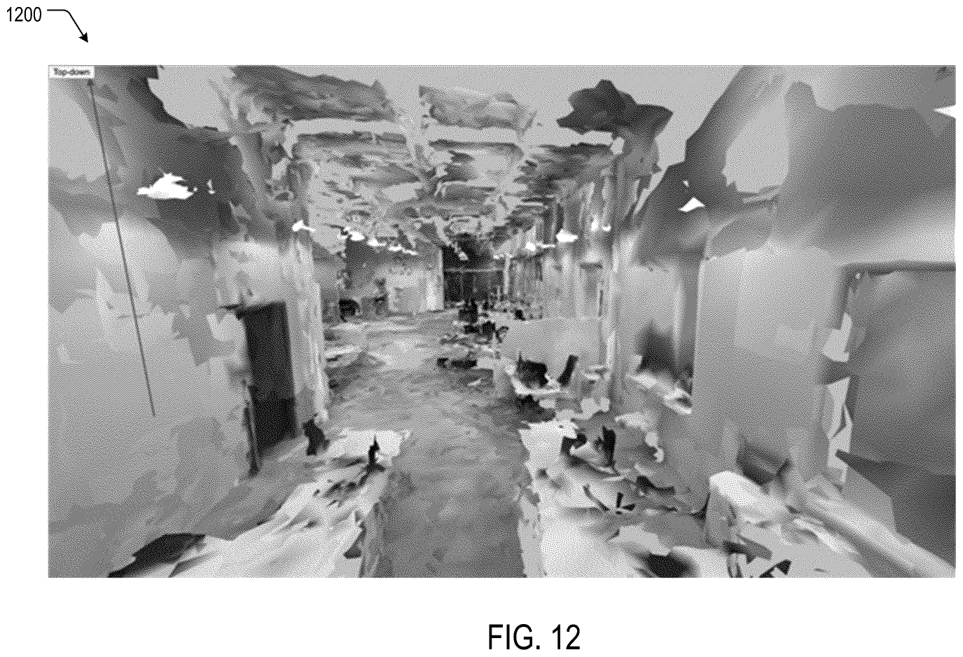

FIG. 12 illustrates a mesh visualization 1200 of a physical environment that may be generated as part of a three-dimensional scanning and visualization operations according to some implementations. The mesh visualization 1200 may represent a scanned interior environment and may or may not incorporate color information to enhance the interpretability and visual clarity of the mesh 1200. For example, the coloring scheme may be applied based on various criteria to convey different aspects of the scanned environment. In some aspects, colors may be used to indicate continuous surfaces, such that each distinct color corresponds to a different surface or structural element within the scanned space. For example, walls, floors, ceilings, and other architectural features may be assigned unique colors to help users distinguish between different geometric components of the environment. In some cases, the color information may represent height-based visualization, such that different colors correspond to specific height ranges within the scanned environment. This height-based coloring approach may provide users with an intuitive understanding of the vertical characteristics of the space, such as with warmer colors potentially representing higher elevations and cooler colors indicating lower areas. The height-based coloring may enable users to quickly assess the spatial relationships and elevation changes within the scanned physical environment or even different stories or levels of a multistory building or environment. In some implementations, the coloring scheme may be applied based on object classification or semantic segmentation, such that different colors represent distinct object types or functional elements within the environment. Structural components such as walls, doors, windows, or architectural details may be assigned specific colors to enhance the semantic understanding of the scanned space. This object-based coloring approach may help users identify and analyze different functional areas or features within the physical environment. In some cases, color may be used to indicate a quality of the scan or data captured by the user during a scanning session. For instance, the quality indicators may be used to assist the user in identifying regions of the physical environment that should be rescanned or at which additional data should be captured.

In some aspects, the mesh 1200 may incorporate actual color data associated with the corresponding physical objects or features captured during the scanning process. The texture information and visual appearance of surfaces may be preserved and displayed to create a photorealistic representation of the scanned environment. In some cases, the mesh 1200 may be presented in black and white or grayscale format to the user to reduce processing time and speed for which the initial or preliminary mesh visualization 1200 may be displayed to the user (e.g., during a scanning session).

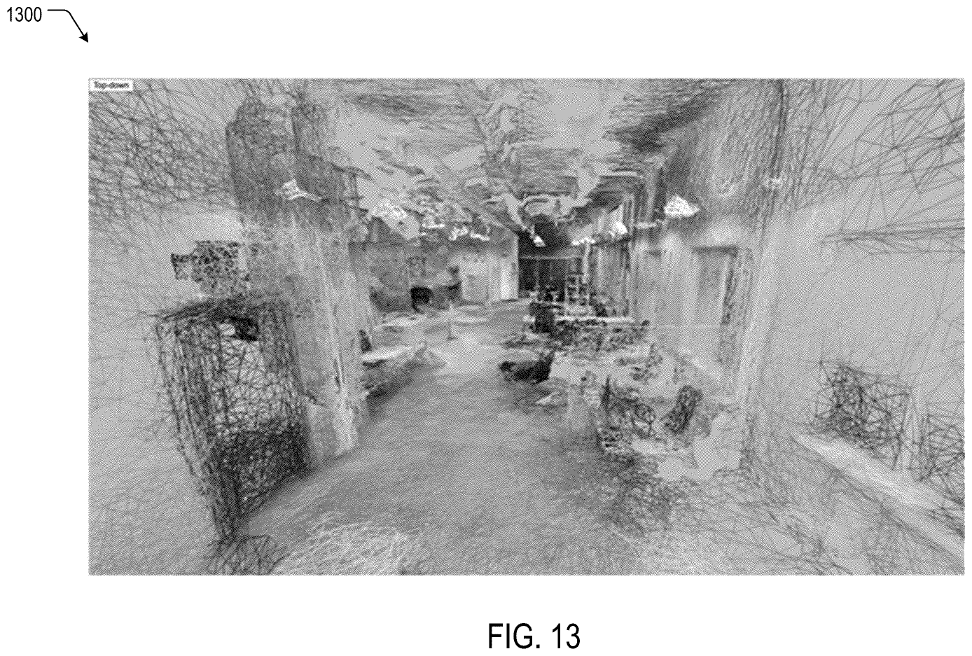

FIG. 13 illustrates a vertex visualization 1300 (such as a colored vertex visualization) of a physical environment that may be generated during three-dimensional scanning and visualization operations according to some implementations. The vertex visualization 1300 may represent an edge-based rendering of a scanned interior physical environment through line-based visualization techniques. In some cases, the vertex visualization 1300 may be presented to users during intermediate processing stages to provide visual feedback regarding the reconstruction progress while maintaining computational efficiency suitable for real-time display.

In some aspects, the vertex visualization 1300 may show architectural features such as walls, doorways, ceiling structures, and other structural elements through edge-based representations that emphasize the underlying geometric framework of the scanned environment. The edge-based representations may allow users to observe the connectivity and topology of the reconstructed mesh while the system performs additional processing operations such as texturing, hole filling, or plane alignment. In some implementations, the vertex visualization 1300 may serve as an intermediate representation between point cloud displays and fully textured mesh visualizations, providing users with progressively refined feedback as the three-dimensional model develops throughout the scanning and post-processing pipeline.

In some cases, the vertex visualization 1300 may be rendered without color information or with limited color palettes (such as to differentiate surfaces, objects, features, and/or the like) to reduce processing overhead and enable faster visualization updates during scanning sessions. The edge-based rendering approach may provide users with clear visibility of the geometric structure and spatial relationships within the scanned environment while minimizing computational requirements. In some aspects, the vertex visualization 1300 may incorporate back-face culling techniques to hide edges associated with polygons facing away from the viewer, thereby reducing visual clutter and improving the readability of the three-dimensional structure.

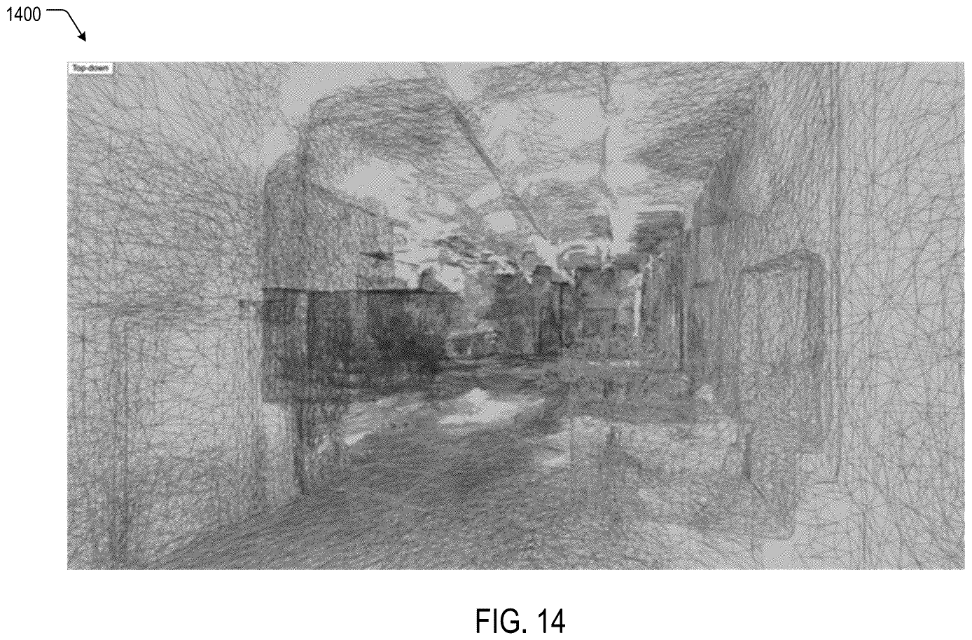

FIG. 14 illustrates a wireframe visualization 1400 (such as a black and white wireframe visualization) of a physical environment that may be generated during three-dimensional scanning and visualization operations according to some implementations. The wireframe visualization 1400 may represent a scanned interior physical environment through edge-based rendering techniques that emphasize the underlying mesh topology. In some cases, the wireframe visualization 1400 may be presented to users during intermediate processing stages to provide visual feedback regarding the reconstruction progress while maintaining computational efficiency suitable for real-time display on mobile devices.

In some aspects, the wireframe visualization 1400 may show architectural features such as walls, doorways, ceiling structures, and other structural elements through line-based representations that highlight the connectivity and edge relationships within the reconstructed mesh. The wireframe rendering approach may allow users to observe the geometric framework of the scanned environment while the system performs additional processing operations such as texturing, hole filling, or plane alignment. In some implementations, the wireframe visualization 1400 may be rendered with varying line thicknesses or edge emphasis to enhance the visibility of geometric features and improve the readability of the three-dimensional structure.

In some cases, the wireframe visualization 1400 may also incorporate back-face culling techniques to hide edges associated with polygons facing away from the viewer, thereby reducing visual clutter and improving the interpretability of architectural details within the scan data. The edge-based rendering may provide users with clear visibility of the mesh connectivity and spatial relationships while minimizing computational requirements compared to fully rendered surface visualizations. In some examples, the wireframe visualization 1400 may serve as an intermediate representation between point cloud displays and solid mesh visualizations, providing users with progressively refined feedback as the three-dimensional model develops throughout the scanning and post-processing pipeline.

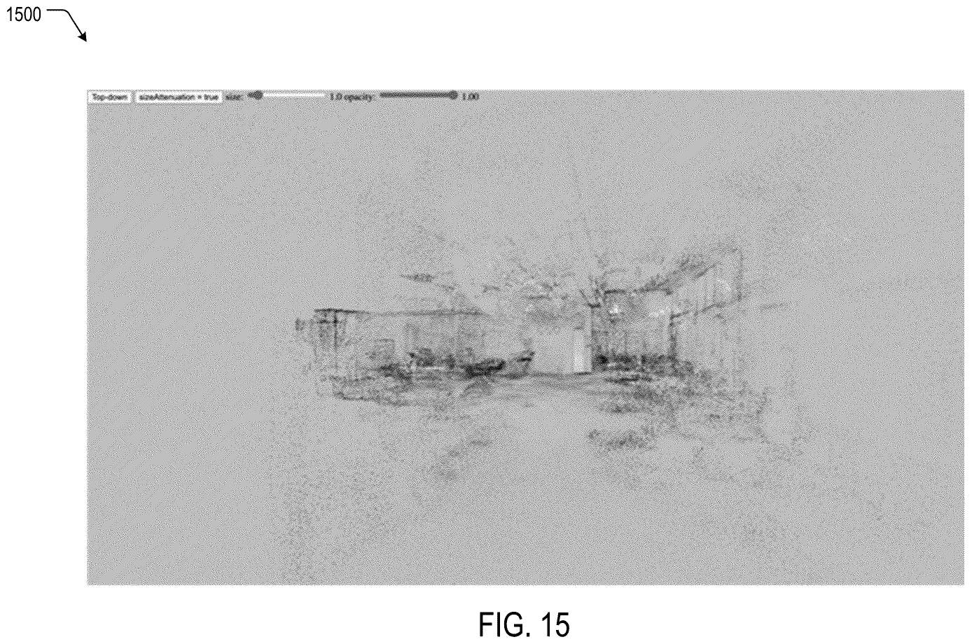

FIG. 15 illustrates a point cloud visualization 1500 of a physical environment that may be generated during three-dimensional scanning and visualization operations according to some implementations. The point cloud visualization 1500 may represent a scanned interior physical environment through point-based rendering techniques that emphasize the spatial distribution of captured sensor data. In some cases, the point cloud visualization 1500 may be presented to users during early processing stages to provide immediate visual feedback regarding the reconstruction progress while maintaining computational efficiency suitable for substantially real-time display on mobile devices.

In some aspects, the point cloud visualization 1500 may show architectural features such as walls, doorways, ceiling structures, and other structural elements through discrete point representations that capture the three-dimensional coordinates of surfaces within the scanned environment. The point-based rendering approach may allow users to observe the density and coverage of captured sensor data while the system performs subsequent processing operations such as mesh generation, surface reconstruction, or geometric refinement. In some implementations, the point cloud visualization 1500 may be rendered with varying point sizes, densities, or visual emphasis to enhance the visibility of geometric features and improve the readability of the three-dimensional structure.

In some cases, the point cloud visualization 1500 may incorporate various coloring schemes to convey different aspects of the captured data. The visualization may utilize height-based coloring where points at different elevations are assigned distinct colors, enabling users to quickly assess the vertical characteristics and spatial relationships within the scanned environment. In some examples, quality-based coloring may be applied where points with higher confidence levels or better sensor accuracy are rendered with different colors or intensities, providing users with immediate feedback about data reliability across different regions of the scan. In some aspects, the point cloud visualization 1500 may employ semantic-based coloring where points belonging to different object types or architectural elements are assigned unique colors to enhance the interpretability of the scanned space.

In some implementations, the point cloud visualization 1500 may be rendered without color information or with limited color palettes to reduce processing overhead and enable faster visualization updates during scanning sessions. The point-based rendering may provide users with an early representation of the scanned environment while minimizing computational requirements compared to mesh-based or surface-based visualizations. In some cases, the point cloud visualization 1500 may serve as an initial representation that precedes wireframe and solid mesh visualizations, providing users with progressively refined feedback as the three-dimensional model develops throughout the scanning and post-processing pipeline.

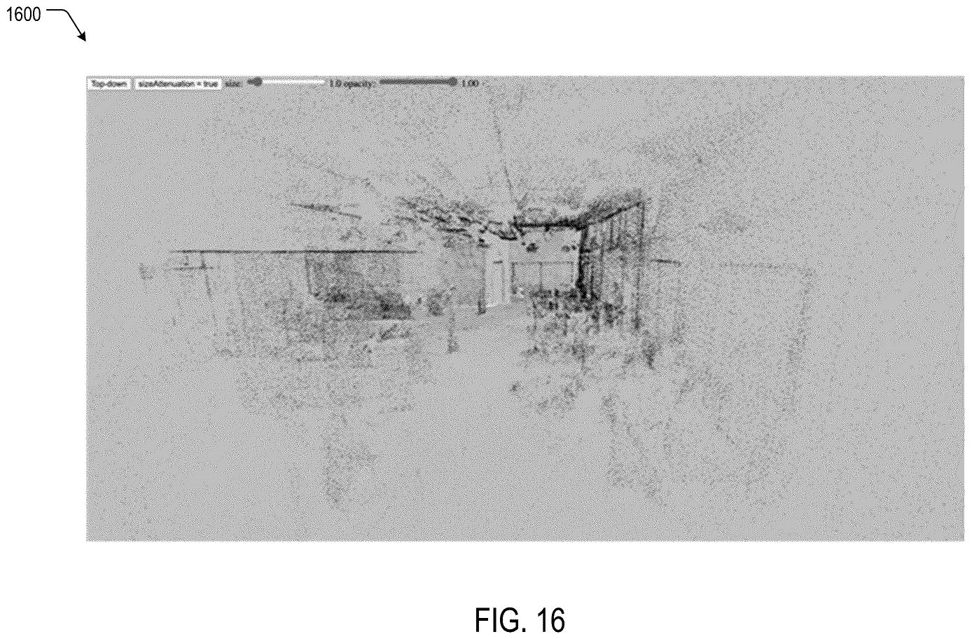

FIG. 16 illustrates a point cloud and directional light visualization 1600 of a physical environment that may be generated during three-dimensional scanning and visualization operations according to some implementations. The point cloud and directional light visualization 1600 may represent a scanned interior physical environment through point-based rendering techniques enhanced with directional lighting effects. In some cases, the point cloud and directional light visualization 1600 may be presented to users during intermediate processing stages to provide visual feedback regarding the reconstruction progress while demonstrating depth perception and spatial relationships through lighting simulation.

In some aspects, the point cloud and directional light visualization 1600 may show architectural features such as walls, doorways, ceiling structures, and other structural elements through discrete point representations that are illuminated by simulated directional light sources. The directional lighting may enhance the three-dimensional perception of the point cloud by creating shading effects that emphasize surface orientations and geometric contours within the scanned environment. In some implementations, the lighting simulation may help users better understand the spatial characteristics and surface properties of the reconstructed geometry compared to uniformly colored point cloud representations.

In some cases, the point cloud and directional light visualization 1600 may incorporate lighting calculations that consider point normal vectors or surface orientations to determine illumination intensity for individual points. The directional light source may be positioned to optimize the visibility of geometric features and enhance the readability of architectural details within the scan data. In some examples, the lighting direction and intensity may be dynamically adjusted based on the viewing perspective or user preferences to provide optimal visualization quality throughout the scanning and post-processing operations.

In some implementations, the point cloud and directional light visualization 1600 may be rendered with varying point sizes, densities, or shading properties to balance visual quality with computational efficiency. The combination of point-based rendering and directional lighting may provide users with an enhanced representation of the scanned environment while maintaining performance suitable for real-time display on mobile devices. In some aspects, the point cloud and directional light visualization 1600 may serve as an intermediate representation that bridges the gap between basic point cloud displays and fully rendered mesh visualizations.

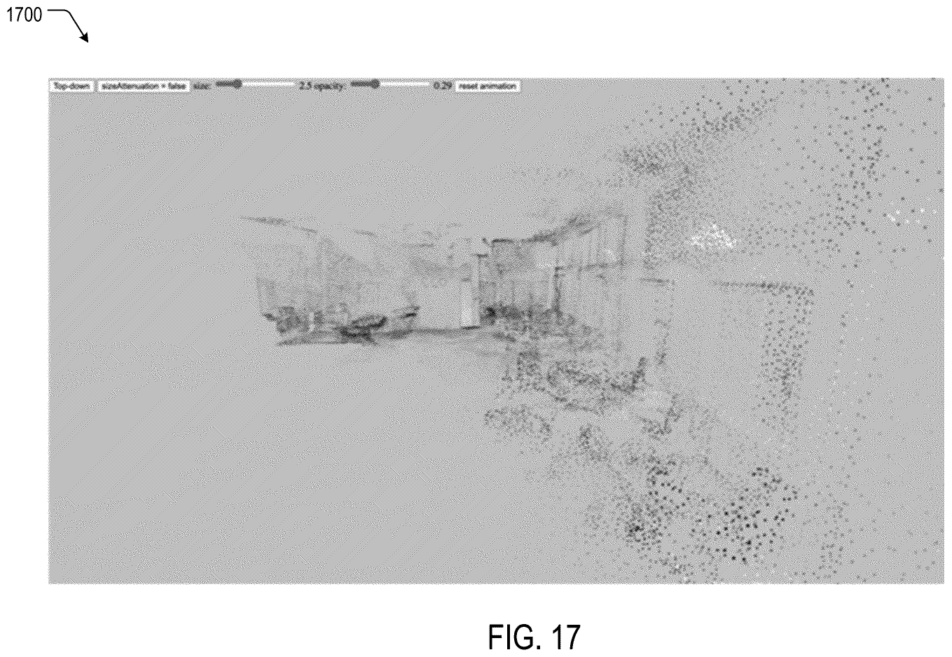

FIG. 17 illustrates an animated point cloud visualization 1700 of a physical environment that may be generated during three-dimensional scanning and visualization operations according to some implementations. The animated point cloud visualization 1700 may represent a scanned interior physical environment through point-based rendering techniques that incorporate dynamic visual effects. In some cases, the animated point cloud visualization 1700 may be presented to users during intermediate processing stages to maintain visual interest while the system performs additional processing operations such as mesh generation, texturing, or geometric refinement.

In some aspects, the animated point cloud visualization 1700 may show architectural features such as walls, doorways, ceiling structures, and other structural elements through discrete point representations that are animated to create visual movement or transitions. The animation effects may include progressive appearance of points, dynamic color transitions, particle-like movements, or other visual effects that convey the evolving nature of the reconstruction process. In some implementations, the animation may be synchronized with the actual data processing progress, providing users with a visual representation of how the three-dimensional model is being constructed from the captured sensor data.

In some cases, the animated point cloud visualization 1700 may incorporate various animation techniques to enhance the viewing experience. Points may appear sequentially based on the order in which frames were captured during the scanning session, creating a temporal replay of the data acquisition process. In some examples, points may fade in or change properties such as size, color, or opacity over time to indicate processing progress or data quality improvements. In some aspects, the animation may include smooth transitions between different visualization states, such as transitioning from a grayscale point cloud to a colorized representation as additional processing operations are completed.

In some implementations, the animated point cloud visualization 1700 may be rendered with varying point sizes, densities, or visual properties that change dynamically throughout the animation sequence. The animation approach may provide users with an engaging representation of the scanned environment while maintaining computational efficiency suitable for real-time display on mobile devices. In some cases, the animated point cloud visualization 1700 may serve as an intermediate representation that provides visual feedback during processing operations, helping to maintain user engagement and patience while the system generates higher quality mesh-based or textured visualizations.

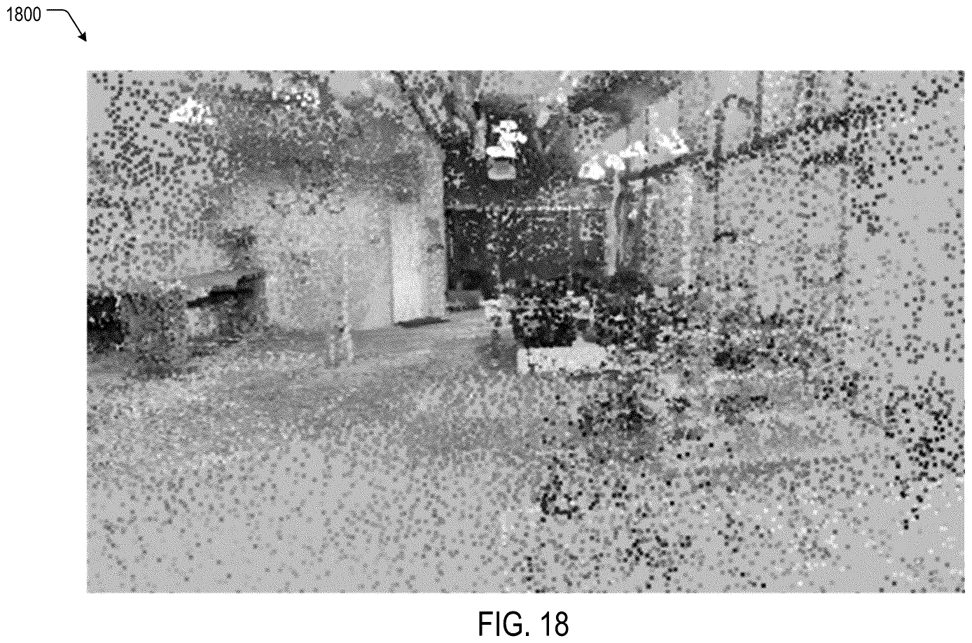

FIG. 18 illustrates another point cloud visualization 1800 of a physical environment that may be generated during three-dimensional scanning and visualization operations according to some implementations. The another point cloud visualization 1800 may represent a scanned interior physical environment through point-based rendering techniques that utilize increased point sizes to enhance visibility and user comprehension. In some cases, the another point cloud visualization 1800 may be presented to users during processing stages to provide visual feedback regarding the reconstruction progress while improving the readability of geometric features through enlarged point representations.

In some aspects, the another point cloud visualization 1800 may show architectural features such as walls, doorways, ceiling structures, and other structural elements through discrete point representations that are rendered with larger point sizes compared to standard point cloud visualizations. The increased point size approach may enhance the visibility of captured sensor data, particularly in areas where point density may be lower or where users may benefit from clearer visual representation of the scanned geometry. In some implementations, the larger point sizes may help users better distinguish individual data points and assess the spatial distribution of captured information across different regions of the scanned environment.

In some cases, the another point cloud visualization 1800 may incorporate variable point sizing where different regions or data quality levels are represented with different point sizes. Points with higher confidence levels or better sensor accuracy may be rendered with larger sizes to emphasize reliable data regions, while areas with lower quality data may utilize smaller point representations. In some examples, the point sizing may be dynamically adjusted based on viewing distance or zoom level to maintain optimal visibility and prevent visual overcrowding as users navigate through the three-dimensional representation.

In some implementations, the another point cloud visualization 1800 may balance the increased point sizes with computational efficiency considerations. The larger point rendering may require additional processing resources, but may provide users with improved visual feedback that enhances their understanding of the reconstruction progress. In some aspects, the system may selectively apply increased point sizes to specific regions of interest or during particular processing stages where enhanced visibility may be most beneficial for user engagement and scan quality assessment.

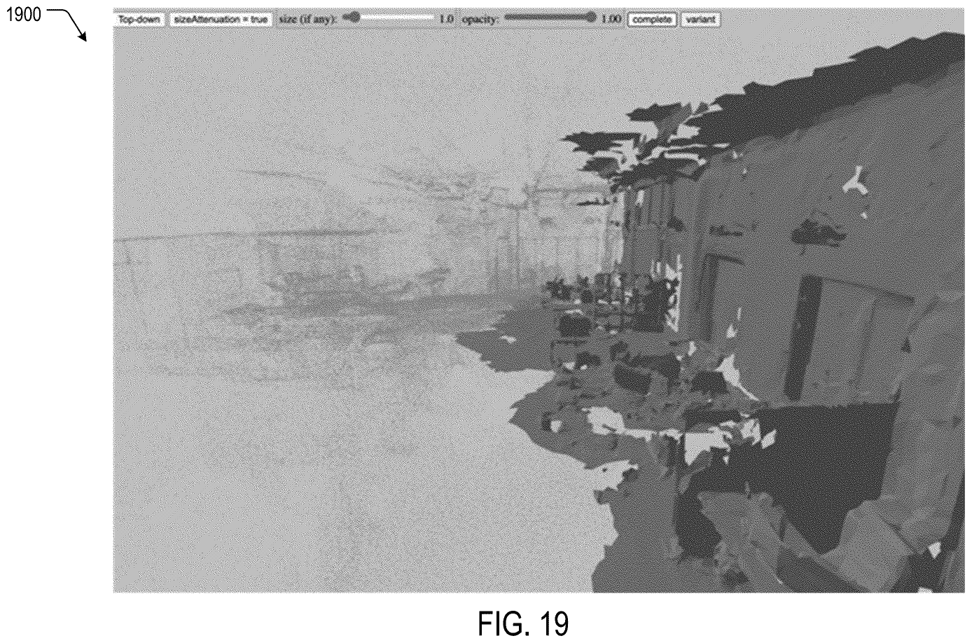

FIG. 19 illustrates a combined mesh and point cloud visualization 1900 of a physical environment that may be generated during three-dimensional scanning and visualization operations according to some implementations. The combined mesh and point cloud visualization 1900 may represent a scanned interior physical environment through a hybrid rendering approach that integrates both mesh-based and point-based visualization techniques. In some cases, the combined mesh and point cloud visualization 1900 may be presented to users during intermediate processing stages to provide comprehensive visual feedback regarding the reconstruction progress while demonstrating multiple levels of geometric detail simultaneously.

In some aspects, the combined mesh and point cloud visualization 1900 may show architectural features such as walls, doorways, ceiling structures, and other structural elements through a combination of surface representations and discrete point data. The hybrid visualization approach may allow users to observe both the continuous surface geometry provided by mesh rendering and the underlying point data distribution captured during the scanning session. In some implementations, the mesh component may represent regions where sufficient data has been processed to generate connected surface geometry while the point cloud component may display areas where data is still being accumulated or where mesh generation has not yet been completed.

In some cases, the combined mesh and point cloud visualization 1900 may incorporate dynamic transitions where point cloud regions progressively convert to mesh representations as processing operations are completed. The transitional effects may include gradual opacity changes, morphing animations, or other visual techniques that demonstrate the evolution from point-based to surface-based representations. In some examples, the system may apply different rendering priorities to ensure that mesh surfaces are displayed prominently while maintaining visibility of underlying point data in regions where surface reconstruction is incomplete.

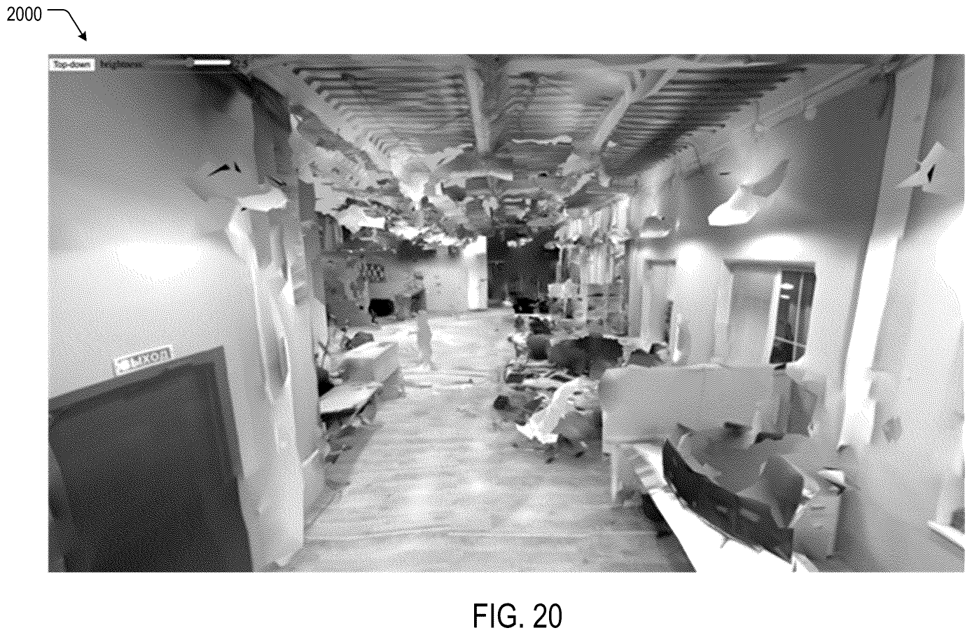

FIG. 20 illustrates a final mesh visualization 2000 of a physical environment that may be generated upon completion of three-dimensional scanning, visualization and post-processing operations according to some implementations. The final mesh visualization 2000 may represent a scanned interior physical environment displaying a fully processed and textured three-dimensional model. In some cases, the final mesh visualization 2000 may be presented to users as the completed output of the scanning and post-processing pipeline, incorporating all refinements including viewpoint bundle reintegration, mesh generation, hole filling, plane alignment, and texturing operations.

In some aspects, the final mesh visualization 2000 may show architectural features such as walls, doorways, ceiling structures, lighting fixtures, and other structural elements through a comprehensive surface representation that includes applied color and texture information. The final mesh visualization 2000 may provide a photorealistic representation of the scanned environment, accurately reflecting the visual appearance of surfaces captured during the scanning session. In some implementations, the final mesh visualization 2000 may incorporate texture generated from selected keyframes to create cohesive visual representations across the entire scanned space.

In some cases, the final mesh visualization 2000 may demonstrate the results of plane alignment operations, where large flat surfaces such as walls, floors, and ceilings exhibit reduced visual noise and improved geometric accuracy. The mesh may include filled holes and interpolated geometry in areas where sensor data was incomplete or unavailable during the scanning process. In some examples, the final mesh visualization 2000 may represent the culmination of all processing stages, providing users with a high-quality three-dimensional model suitable for various visualization, measurement, or analysis purposes.

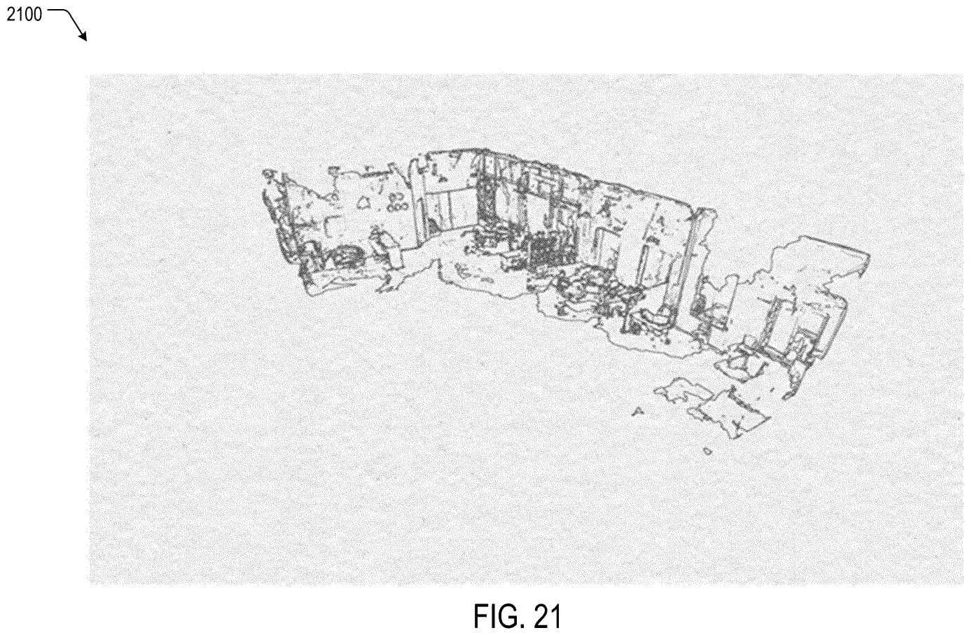

FIG. 21 illustrates a three-dimensional doll house view 2100 of a scanned interior physical environment that may be generated as part of finalized visualization operations according to some implementations. The 3D doll house view 2100 may represent a comprehensive overhead perspective of a reconstructed interior space, displaying multiple rooms and architectural features in a single integrated visualization. In some cases, the 3D doll house view 2100 may be presented to users following completion of post-processing operations to provide an intuitive overview of the entire scanned environment.

In some aspects, the 3D doll house view 2100 may show various architectural elements including walls, doorways, corridors, and room divisions through a rendered three-dimensional representation that removes or makes transparent upper portions such as ceilings and roofs. The visualization approach may enable users to observe the spatial relationships between different areas of the scanned environment from an elevated viewing angle that provides comprehensive coverage of the entire space. In some implementations, the 3D doll house view 2100 may incorporate texture information, geometric refinements, and color data to create a photorealistic representation of the physical environment while maintaining the characteristic top-down perspective that allows interior visibility.

In some cases, the 3D doll house view 2100 may allow users to navigate and explore the scanned environment through interactive viewing controls. Users may rotate, zoom, or pan the visualization to examine different regions or architectural features from various perspectives while maintaining the doll house viewing paradigm. In some examples, the 3D doll house view 2100 may support floor-by-floor navigation in multi-story environments, enabling users to selectively view individual levels or transition between floors to understand the vertical organization of the scanned space.

In some implementations, the 3D doll house view 2100 may be rendered with varying levels of detail depending on the viewing distance or zoom level, potentially optimizing rendering performance while maintaining visual quality. The system may apply level-of-detail techniques to display high-resolution geometry and textures for areas in focus while reducing complexity for distant or peripheral regions. In some aspects, the 3D doll house view 2100 may incorporate lighting effects and shadows to enhance depth perception and spatial understanding, creating a more immersive and visually appealing representation of the reconstructed environment.

In some cases, the 3D doll house view 2100 may serve as a finalized visualization format that demonstrates the complete reconstruction results following all processing operations including viewpoint bundle reintegration, mesh generation, hole filling, plane alignment, and texturing. The comprehensive perspective provided by the 3D doll house view 2100 may enable users to assess the overall quality and completeness of the three-dimensional model, identifying the spatial layout and architectural characteristics of the scanned physical environment in an intuitive and accessible format that facilitates understanding of complex interior spaces.

In some implementations, the 3D doll house view 2100 may represent one alternative type of rendering or visualization format that may be utilized for presenting the finalized three-dimensional model, but other visualization approaches may also be employed depending on user preferences, application requirements, or intended use cases. In some cases, alternative visualization formats may include first-person walkthrough views that simulate navigation through the scanned environment from a ground-level perspective, enabling users to experience the space as if physically present within the reconstructed environment. In some aspects, the visualization may include cross-sectional views that slice through the three-dimensional model at specified planes to reveal internal spatial relationships and structural details. In some cases, the visualization may include exploded views that separate different floors or architectural components to enhance understanding of multi-level structures or complex arrangements. In some examples, the system may provide measurement-annotated views that overlay dimensional information (such as text-based descriptors), area calculations, or volumetric data directly onto the three-dimensional visualization to support quantitative analysis and documentation purposes.

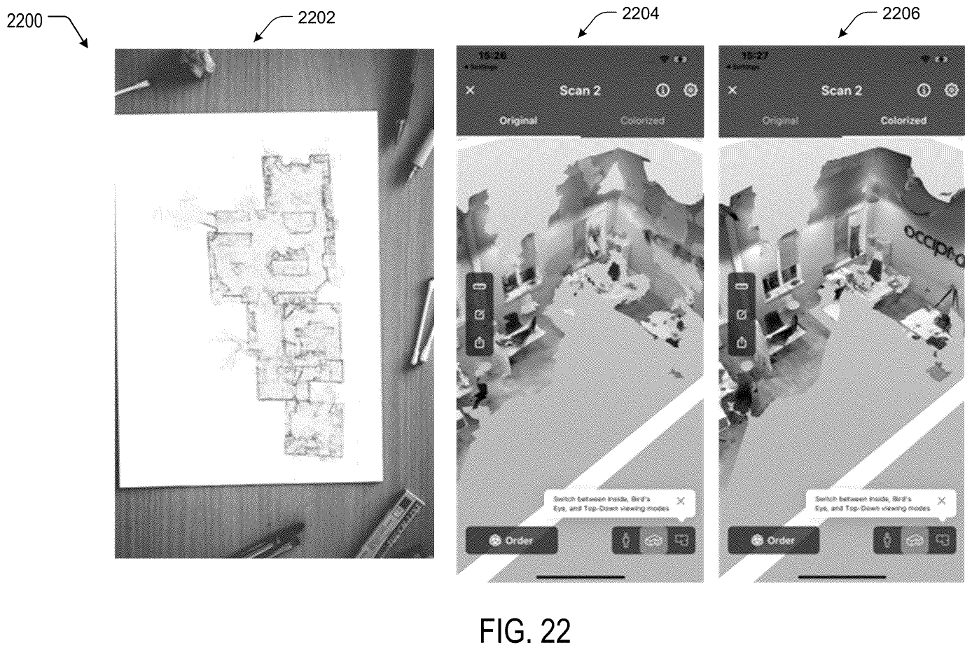

FIG. 22 illustrates user interfaces 2200 showing different display modes for viewing a three-dimensional scan of a physical environment according to some implementations. The user interfaces 2200 may demonstrate how users can transition between different visualization formats using view controls to access various stages of the scanning and processing pipeline. In some cases, the user interfaces 2200 may provide users with the ability to navigate between preliminary visualizations, intermediate processing results, and finalized three-dimensional models through intuitive interface controls.

In some aspects, the user interfaces 2200 may include a first display mode 2202 that presents a traditional two-dimensional floor plan or architectural drawing representation of the scanned environment and/or a three-dimensional doll house view, such as shown in FIG. 21 above. In some cases, the user interfaces 2200 may include a second display mode 2204 that presents a three-dimensional mesh representation (or other preliminary or secondary visualization) of the scanned environment. In some implementations, the user interfaces 2200 may include a third display mode 2206 that displays a finalized visualization. For example, the second display mode 2294 may be an original 3D model of the physical environment while the third display mode 2206 may be a colorized post-processed 3D model. In some cases, the third display mode 2206 may also include enhanced visual quality and accuracy (such as between elements or feature of the model).

In some cases, users may transition between the first display mode 2202, second display mode 2204, and third display mode 2206 using view controls integrated into the user interface. The view controls may enable seamless navigation between different visualization formats, allowing users to compare preliminary visualizations, intermediate processing results, and finalized three-dimensional models.

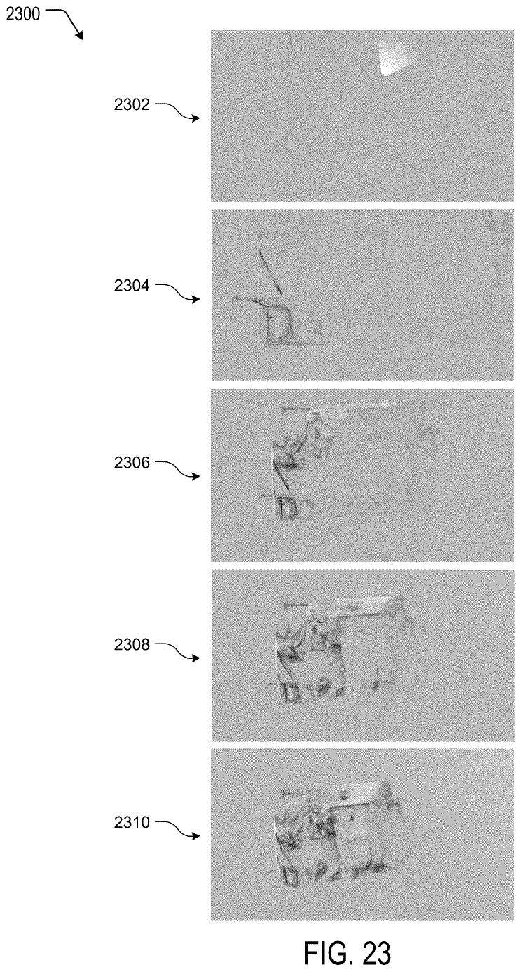

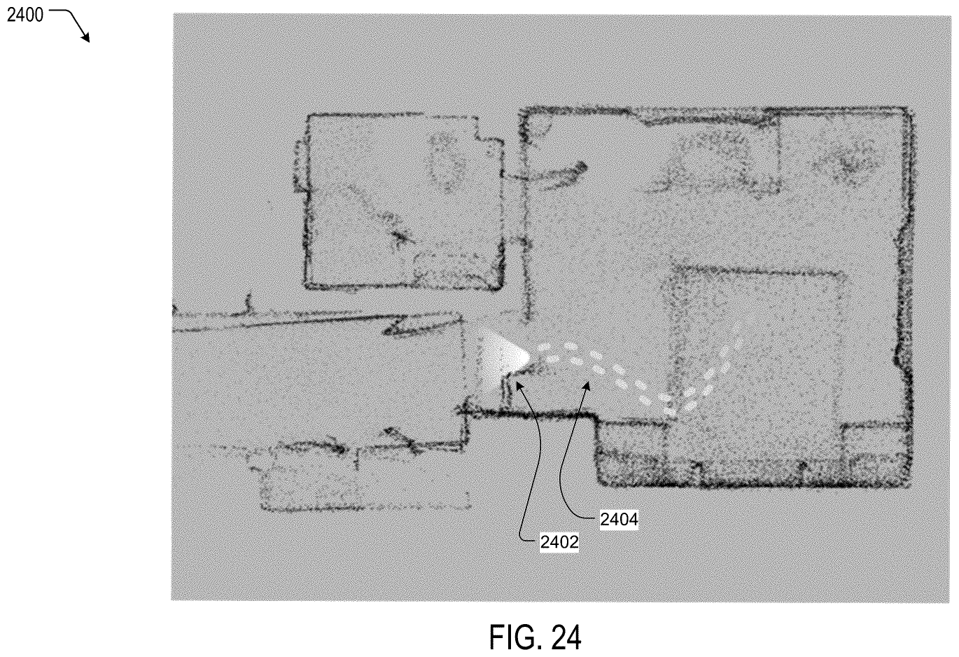

FIG. 23 illustrates a progress bar or status visualization 2300 showing progressive visualization development during three-dimensional scanning, during visualization, and/or during post processing operations according to some implementations. The scanning session 2300 may demonstrate how the three-dimensional model evolves through multiple visualization states as sensor data is captured and/or processed, utilizing dynamic visualization techniques that present geometric primitives in specific sequences rather than simultaneously. In this manner, the updating status visualization 2302-2310 may act as an interactable progress indicator associated with the processing and/or any post processing of the sensor data with respect to the generation of the finalized model.

In some aspects, the scanning session 2300 may include an initial visualization 2302 that establishes the baseline display configuration before geometric data becomes available for rendering. The scanning session 2300 may progress to a first progressive visualization 2304 that presents initial geometric elements using grayscale point cloud representation. In some implementations, the points in the first progressive visualization 2304 may appear in the sequence or time in which the corresponding frames or data were captured during the scanning process enabling users to observe the reconstruction as the reconstruction unfolds.

In some cases, the scanning session 2300 may advance to a second progressive visualization 2306 that transitions the point cloud representation from grayscale to colorized visualization. In some examples, the second progressive visualization 2306 may incorporate height-based coloring, quality-based coloring, or semantic-based coloring to convey different aspects of the captured data as the visualization develops. In some implementations, the scanning session 2300 may continue to a third progressive visualization 2308 that demonstrates primitive type progression by transitioning from point cloud representation to, for example, wireframe mesh visualization. The wireframe elements may be visualized on top of or in place of the previously displayed point cloud data, following the same sequential order based on the original data capture sequence. In some examples, the scanning session 2300 may continue with a final progressive visualization 2310 that presents a solid mesh representation with applied texture information.

FIG. 24 illustrates a top-down point cloud visualization 2400 of a physical environment that may be generated during three-dimensional scanning and visualization operations according to some implementations. The top-down point cloud visualization 2400 may represent a scanned interior physical environment through an overhead perspective that displays the spatial layout and scanning trajectory information. In some cases, the top-down point cloud visualization 2400 may be presented to users during scanning sessions to provide visual feedback regarding the scanning coverage and device movement patterns.

In some aspects, the top-down point cloud visualization 2400 may include a scanning cone 2402 that represents the user's or image device viewpoint and focus during the scanning process. The scanning cone 2402 may provide a visual representation of the capture device's position and orientation at a particular moment during the scanning session, indicating the direction and field of view of the sensor system.

In some cases, the top-down point cloud visualization 2400 may include a scanning path or trajectory 2404 that traces the movement of the capture device throughout the scanning session. The scanning path or trajectory 2404 may be visualized as a trail or line that follows the sequence of positions occupied by the scanning device as the user moved through the physical environment. In some implementations, the scanning path or trajectory 2404 may provide users with a visual record of their movement patterns enabling the user to identify areas that may require additional scanning coverage or regions where scanning density may be insufficient.

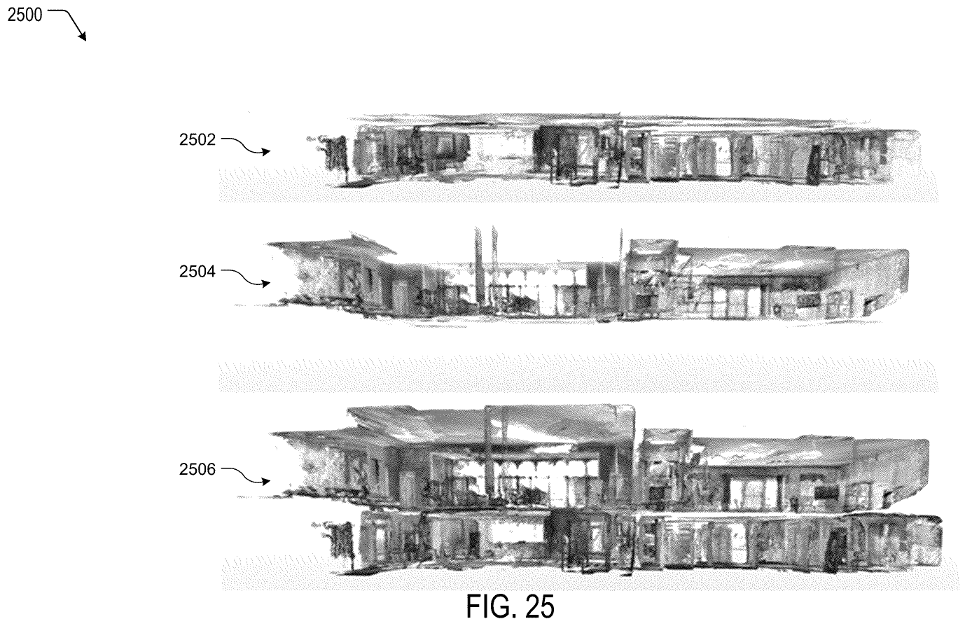

FIG. 25 illustrates a multistory building visualization 2500 including a first floor visualization 2502, a second floor visualization 2504, and a multistory building visualization 2506 according to some implementations. The multistory building visualization 2500 may demonstrate how the system processes and displays multi-floor environments by presenting individual floor levels sequentially to maintain visual clarity and prevent overlap-related confusion that may occur when multiple floors are displayed simultaneously.

In some aspects, the multistory building visualization 2500 may include a first floor visualization 2502 that presents the ground level of the scanned building in an overhead or doll house perspective. The first floor visualization 2502 may display architectural features such as walls, doorways, room divisions, corridors, and other structural elements corresponding to the lowest level of the multi-story structure. The multistory building visualization 2500 may include a second floor visualization 2504 that presents the next level of the scanned building structure. In some implementations, the multistory building visualization 2500 may include a third visualization 2506 that presents an integrated view of both the first and second stories.

FIG. 26 illustrates a scanning session visualization sequence 2600 showing progressive model updates according to some implementations. In the current example, the scanning session visualization sequence 2600 may demonstrate how a top-down point cloud visualization evolves as captured sensor data is incrementally added to the three-dimensional model. However, it should be understood that various other types of models could be used including 3D models in lieu of the top-down point cloud visualization currently illustrated.

In some aspects, the scanning session visualization sequence 2600 may include a first visualization 2602 that presents an initial top-down point cloud view at the beginning of the scanning session. The first visualization 2602 may show a limited first visualization 2612(1) corresponding to the initial frames captured by the sensor system. In some implementations, the first visualization 2612(1) may include a scanning cone 2614 that represent the capture device's current or position and orientation at the time the corresponding sensor data was captured.

In some cases, the scanning session visualization sequence 2600 may progress to a second visualization state 2604 that displays additional point cloud data as the user continues scanning the physical environment. The second visualization 2612(2) may show an expanded spatial coverage compared to the first visualization 2612(1), reflecting the accumulation of sensor data from consecutive frames. In some examples, the point cloud density may increase in regions that have been scanned multiple times, while new areas may appear as the capture device moves through the environment.

In some implementations, the scanning session visualization sequence 2600 may advance to a third visualization 2606 that presents further expansion of the point cloud representation. The third visualization 2612(3) may demonstrate continued growth of the scanned area as additional frames are captured and processed. In some aspects, the scanning path or trajectory may extend to show the user's movement through the physical environment, providing a visual record of the scanning coverage pattern.

In some cases, the scanning session visualization sequence 2600 may continue to a fourth visualization 2612(4) that displays a more comprehensive point cloud representation with increased spatial extent and data density. The fourth visualization 2612(4) may show the progressive accumulation of geometric information as the user scans additional regions of the physical environment. In some examples, the visualization may incorporate color information or height-based coloring to enhance the interpretability of the captured data.

In some implementations, the scanning session visualization sequence 2600 may culminate in a fifth visualization 2612(X) that presents a substantially complete top-down point cloud view of the scanned environment. The fifth visualization 2612(X) may represent the state of the preliminary three-dimensional model at the conclusion of the scanning session or at an advanced stage of data capture. In some aspects, the fifth visualization 2612(X) may display the full extent of the scanned area with comprehensive point cloud coverage, enabling users to assess the completeness and quality of the captured data before proceeding to post-processing operations.

In some cases, the display may transition from first visualization to the fifth visualization dynamically during the scanning session as new sensor data becomes available. The progressive visualization approach may enable users to observe the continuous development of the three-dimensional model in real-time, providing immediate feedback about scanning coverage and data quality. In some implementations, the top-down perspective may allow users to identify gaps or areas with insufficient coverage, enabling them to adjust their scanning patterns to improve the completeness of the final three-dimensional model.

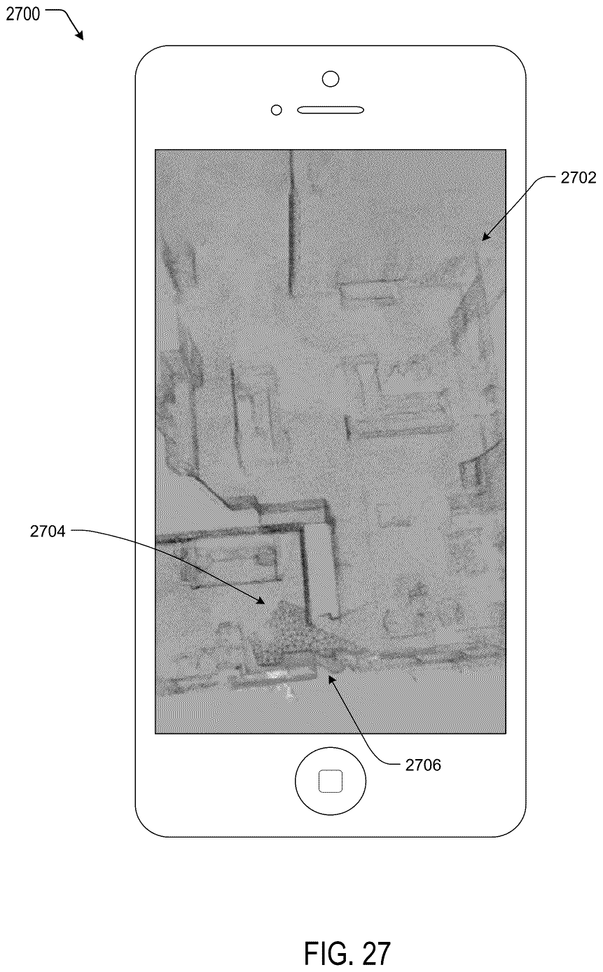

FIG. 27 illustrates a transition visualization 2700 that may be generated during initial post-processing operations or later stages of a scanning session according to some implementations. The transition visualization 2700 may represent an intermediate processing state that occurs following the visualization sequence shown in FIG. 26, providing users with visual feedback as the system begins refining the captured sensor data. In some cases, the transition visualization 2700 may be presented to users to indicate that preliminary scanning operations have concluded and that post-processing operations are commencing or progressing.

In some aspects, the transition visualization 2700 may include enhanced geometric representations compared to the preliminary visualizations presented during active scanning. The transition visualization 2700 may include three-dimensional aspects, color, wireframes, meshes, and/or the like. In some cases, the transition visualization 2700 may display a combination of point cloud elements and emerging mesh surfaces, illustrating the progressive conversion from discrete point data to connected surface geometry. The visualization may show regions or portions 2704 and/or 2706 where mesh generation has been completed overlaid on areas that remain in point cloud representation, providing users with insight into the processing progress. For example, portion 2704 shows a wireframe overlaid on the three-dimensional point cloud visualization and the portion 2706 shows a mesh overlaid on the three-dimensional point cloud visualization. In some examples, the transition visualization 2700 may utilize visual indicators such as color gradients, opacity variations, or animation effects to distinguish between fully processed regions and areas still undergoing refinement operations.

In some aspects, the transition visualization 2700 may serve as a bridge between the real-time preliminary visualizations generated during scanning and the higher-quality final visualizations that emerge as post-processing operations progress. In this manner, the transition visualization 2700 may act as a secondary visualization. In some cases, the transition visualization 2700 may be accompanied by progress indicators or status information that inform users about the current post-processing stage and estimated completion time. The visualization may update dynamically as processing operations advance, showing incremental improvements in geometric quality, texture application, or surface refinement. In some implementations, the transition visualization 2700 may enable users to observe the transformation of raw sensor data into refined three-dimensional models, maintaining user engagement during the processing interval between scanning completion and finalized visualization availability.

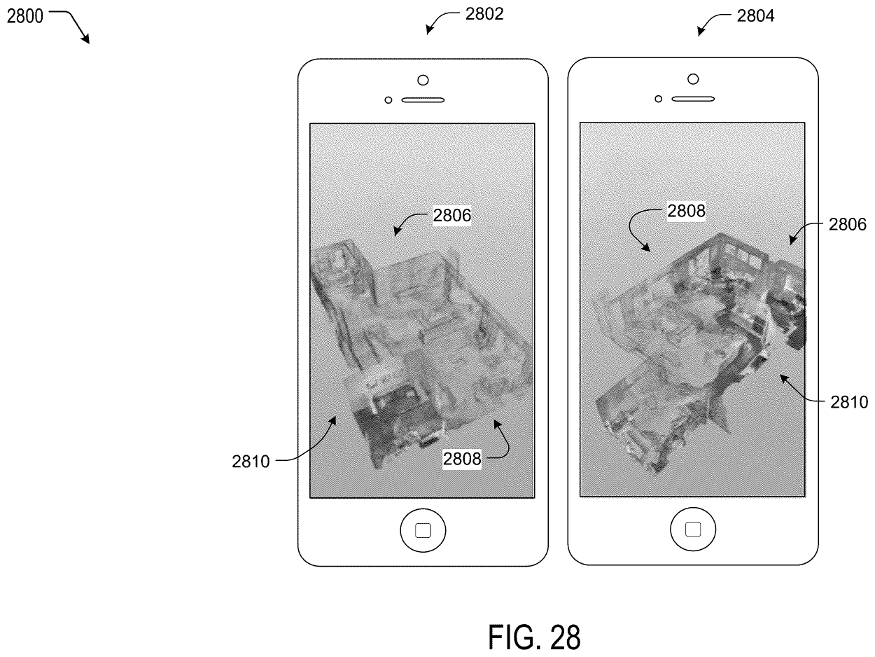

FIG. 28 illustrates a scanning session visualization sequence 2800 showing progressive visualization development during post processing operations according to some implementations. The scanning session visualization sequence 2800 may demonstrate how the three-dimensional model evolves through multiple visualization states as sensor data is captured and processed, utilizing dynamic visualization techniques that present geometric primitives in specific sequences rather than simultaneously.

In some aspects, the scanning session visualization sequence 2800 may include a first visualization 2802 that establishes the baseline display configuration before geometric data becomes available for rendering. The first visualization 2802 may present an initial display area on a mobile device screen with interface elements and controls that enable users to interact with the scanning system. In some implementations, the first visualization 2802 may include status indicators, progress information, or instructional guidance to assist users in initiating the scanning session. In some cases, the first visualization 2802 may include the model representation 2806 of the physical environment that includes a portion in point cloud 2808 (from the preliminary representations of FIG. 26), as well as a portion of mesh 2810 generated, for example, during post processing.

As the post processing progresses, the second visualization 2804 may be presented in which a larger portion of the model representation 2806 may be shown as mesh 2810 and less of the second visualization 2804 may be illustrated as point cloud 2808. It should be understood, that this process may continue until an entire mesh 3D model 2810 is generated completely replacing the point cloud portion 2808.

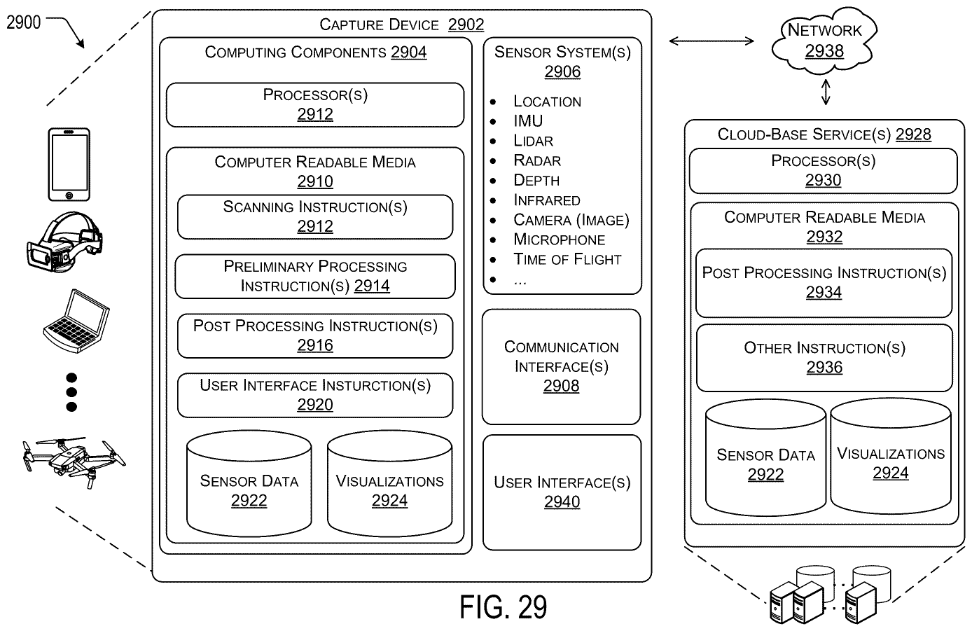

FIG. 29 illustrates a block diagram of a system 2900 for processing three-dimensional scans and generating progress visualizations according to some implementations. For example, the system 2900 may include a capture device 2900 that may be configured to capture sensor data from physical environments and perform real-time processing operations during scanning sessions. The mobile device 2900 may include computing components 2904 that provide processing capabilities for visual-inertial tracking, viewpoint bundle management, and preliminary visualization generation. In some cases, the mobile device 2900 may communicate with cloud-based service(s) 2928 via a network 2938 to enable distributed processing architectures where computationally intensive operations may be offloaded to remote processing resources. It should be understood that, in some examples, the processing operations described herein may be performed solely on the mobile device 2900 without requiring external computational resources. In other examples, the mobile device 2900 may utilize various cloud-based services or resources 2928 to assist with processing, such as the post processing after the preliminary visualizations are displayed to the user.

The capture device 2900 may include one or more sensor system(s) 2906 that enable acquisition of three-dimensional data from physical environments. The sensor system(s) 2906 may include depth sensors such as lidar systems, time-of-flight sensors, or structured light sensors that capture spatial information about surfaces and objects within the scanning area. In some implementations, the sensor system(s) 2906 may include camera sensors that capture image data for texture generation and visual tracking operations. The sensor system(s) 2906 may also include inertial measurement units (IMUs) that provide position and orientation data for device tracking and pose estimation during scanning sessions. In some aspects, the sensor system(s) 2906 may include additional sensors such as radar sensors, infrared sensors, microphone sensors, or location sensors that may enhance the data capture capabilities and provide supplementary information for three-dimensional reconstruction operations.

The capture device 2900 may also include one or more user interfaces 2940 that may act as an input and/or output interface for the user. For example, the one or more user interfaces 2940 may include one or more display and/or one or more input devices. In some cases, the user interface 2940 may act as a combined input and output device, such as a touch enabled display or immersive or semi-immersive headset.

The computing components 2904 may include one or more processor(s) 2912 and computer readable media 2910. Each of the processor(s) 2912 may itself comprise one or more processors or processing cores configured to execute instructions for three-dimensional scan processing operations. The computer readable media 2910 may include volatile media such as random access memory (RAM) and nonvolatile media such as read only memory (ROM), Flash memory, optical disks, or magnetic disks. In some cases, the computer readable media 2910 may include fixed media such as GPU, NPU, RAM, ROM, or fixed hard drives, as well as removable media such as Flash memory, removable hard drives, or optical discs. The computer readable media 2910 may be configured in a variety of ways to support the storage and execution of processing instructions and data management operations.

Several modules such as instructions and data stores may be stored within the computer readable media 2910 and configured to execute on the processor(s) 2912. For example, the computer readable media 2910 may store preliminary processing instruction(s) 2914, post processing instruction(s) 2916, and other processing instructions that enable various stages of three-dimensional scan processing. The computer readable media 2910 may also be configured to store sensor data 2922 captured during scanning sessions and visualizations 2924 generated through processing operations. In some implementations, the capture device 2900 may include communication interface(s) 2908 that enable data exchange with external systems and services via the network 2938.

The preliminary processing instruction(s) 2914 may be configured to perform real-time processing operations during scanning sessions including visual-inertial tracking, viewpoint bundle management, and preliminary visualization generation. The preliminary processing instruction(s) 2914 may utilize sensor data from the sensor system(s) 2906 to estimate frame poses, accumulate consecutive frames into viewpoint bundles, and generate mesh representations for display to users during active scanning operations. In some aspects, the preliminary processing instruction(s) 2914 may include plane detection algorithms that extract three-dimensional planes from captured geometries and pose optimization techniques that refine viewpoint bundle positions using geometric constraints.

The post processing instruction(s) 2916 may be configured to perform refinement operations on captured sensor data following completion of scanning sessions. The post processing instruction(s) 2916 may include viewpoint bundle reintegration operations that incorporate optimized pose information, partitioning algorithms that subdivide scanning volumes into manageable sections, and mesh generation techniques that construct high-resolution geometric representations. In some implementations, the post processing instruction(s) 2916 may include hole filling operations that address gaps in captured data, plane alignment algorithms that improve surface quality, and texturing operations that apply visual information to three-dimensional models.

The capture device 2900 may include user interface instruction(s) 2920 that enable user interaction with the scanning system and visualization of processing results. The user interface(s) 2920 may include display screens that present preliminary visualizations during scanning sessions and finalized three-dimensional models following post-processing operations. In some cases, the user interface(s) 2920 may include touch interfaces, voice controls, or gesture recognition systems that allow users to control scanning parameters, navigate visualizations, or initiate processing operations.

The cloud-based service(s) 2928 may include one or more processor(s) 2930 and computer readable media 2932 that provide enhanced processing capabilities for three-dimensional scan refinement operations. The processor(s) 2930 may comprise high-performance computing resources that enable accelerated processing of large-scale scan data or complex geometric operations that may exceed the capabilities of mobile devices. The computer readable media 2932 may store post processing instruction(s) 2934 and other instruction(s) 2936 that implement advanced algorithms for mesh generation, texture synthesis, or geometric optimization.

The cloud-based service(s) 2928 may receive sensor data 2922 from the capture device 2900 via the network 2938 and generate enhanced visualizations 2924 that may be transmitted back to the capture device 2900 or made available through web-based interfaces. In some implementations, the cloud-based service(s) 2928 may provide machine learning capabilities that enhance scan processing through automated feature recognition, semantic segmentation, or quality assessment operations. The distributed architecture may enable the system 2900 to balance real-time performance requirements with computational complexity by performing preliminary operations on the capture device 2900 while leveraging cloud resources for intensive refinement processes.

A number of implementations have been described. Nevertheless, it will be understood that various modifications may be made without departing from the spirit and scope of the disclosure. Accordingly, other implementations are within the scope of the following claims.

### EXAMPLE CLAUSES

A. A method comprising: receiving, during a scanning session of a physical environment, frames and position and orientation data from a capture device; estimating, based at least in part on the position and orientation data, frame poses of the capture device; merging consecutive frames into a current viewpoint bundle; generating, based at least in part on the current viewpoint bundle, a preliminary visualization; and presenting the preliminary visualization on a display prior to a completion of the scanning session to provide visual feedback regarding three-dimensional model reconstruction.

B. The method of A, wherein presenting the preliminary visualization comprises overlaying the preliminary visualization on a field of view a sensor associated with the capture device.

C. The method of A, wherein presenting the preliminary visualization comprises presenting a scanning cone and a scanning path on the display concurrently with the preliminary visualization.

D. The method of A, wherein the preliminary visualization is at least one of the following: a solid mesh visualization, a wireframe visualization, a point cloud visualization, a stylized model visualization, a vertex visualization, an animated point cloud visualization, a point cloud and directional light visualization, or a combined mesh and point cloud visualization.

E. The method of A, wherein the preliminary visualization includes color information that indicates at least one of the following: height-based characteristics including different colors corresponding to different elevation levels within the physical environment, quality-based characteristics including different colors corresponding to different confidence levels or detail metrics associated with a state of the scanning session, object data including different colors corresponding to different objects within the physical environment, surface continuity including different colors corresponding to different surfaces within the physical environment, or processing status including different colors corresponding to different stages of data processing or reconstruction completion.

F. The method of A, wherein the preliminary visualization is a first preliminary visualization and the method further comprises replacing the first preliminary visualization with a second preliminary visualization as the second preliminary visualization becomes available.

G. The method of A, further comprising presenting a progress indicator on the display concurrently with the preliminary visualization, the progress indicator indicating a status of post processing operations.

H. One or more computer-readable medium storing instructions that, when executed by one or more processors, cause the one or more processors to perform operations comprising: receiving, during a scanning session of a physical environment, frames and position and orientation data from a capture device; generating, during the scanning session, a preliminary visualization; presenting the preliminary visualization on a display prior to a completion of the scanning session to provide visual feedback to a user; generating, during post processing operations a secondary visualization; presenting the secondary visualization on the display; generating a final visualization; and presenting the final visualization on the display.

I. The one or more computer-readable medium of H, wherein: the preliminary visualization is at least one of a point cloud visualization, a wireframe visualization, or a vertex visualization, a solid mesh visualization, a stylized model visualization, a combined mesh and point cloud visualization, a textured model visualization, a three-dimensional doll house model visualization, or a first person viewpoint visualization; the secondary visualization is at least one of a point cloud visualization, a wireframe visualization, or a vertex visualization, a solid mesh visualization, a stylized model visualization, a combined mesh and point cloud visualization, a textured model visualization, a three-dimensional doll house model visualization, or a first person viewpoint visualization; and the final visualization is at least one of a point cloud visualization, a wireframe visualization, or a vertex visualization, a solid mesh visualization, a stylized model visualization, a combined mesh and point cloud visualization, a textured model visualization, a three-dimensional doll house model visualization, or a first person viewpoint visualization.

J. The one or more computer-readable medium of H, wherein the secondary visualization includes a series of visualizations associated with different portions of the physical environment, the individual visualizations of the series of visualizations are displayed as post processing operations on each individual portion of the physical environment are completed.

K. The one or more computer-readable medium of J, wherein the displaying the series of visualizations further comprises: establishing ga width parameter and a height parameter for defining an available screen area of the display; and determining a zoom associated with the series of visualizations based at least in part on a ratio between the width parameter and height parameter and a width and a height of a bounding box associated with one or more of the portions of the physical environment represented by the series of visualizations.

L. The one or more computer-readable medium of H, wherein the post processing operations further comprise: partitioning a scanning volume into a plurality of partitions; generating, for individual partitions of the plurality of partitions, high-poly meshes; merging the high-poly meshes into a mesh representation; and texturing the mesh representation to generate the final visualization.

M. The one or more computer-readable medium of H, further comprising presenting a progress indicator on the display concurrently with the secondary visualization, the progress indicator indicating a status of the post processing operations.

N. The one or more computer-readable medium of H, wherein the secondary visualization includes color to indicate planar surface, objects, and height levels within the physical environment.

O. The one or more computer-readable medium of H, wherein the secondary visualization includes a first visualization for a first floor of the physical environment, a second visualization for a second floor of the physical environment, and a third visualization for a combined visualization of the first floor and second floor.

P. A system comprising: one or more displays; one or more processors; and one or more computer readable media storing instructions that, when executed by the one or more processors, cause the one or more processors to perform operations comprising: receiving first frames of a physical environment from a capture device; presenting, based at least in part on the first frames and on the display, a first visualization representing a first portion of the physical environment, the first visualization having a first type; receiving second frames of the physical environment from a capture device; presenting, based at least in part on the first frames and the second frames and on the display, a second visualization representing a first portion and a second portion of the physical environment, the second visualization having the first type; processing, the first frames and the second frames, to generate a third visualization representing the first portion and the second portion of the physical environment, the third visualization of a second type different than the first type of the first visualization and the second visualization; and presenting, on the display over at least a portion of the first visualization or the second visualization, the third visualization.

Q. The system of P, wherein the first visualization and the second visualization are point cloud representation and the third visualization is a mesh or wireframe representation.

R. The system of P, the operations further comprising: further processing, the first frames and the second frames, to generate a fourth visualization representing the first portion and the second portion of the physical environment; and presenting, on the display over at least a portion of the first visualization or the second visualization, the fourth visualization.

S. The system of P, wherein the first visualization and the second visualization are top down representation and the third visualization is a three-dimensional representation.

T. The system of P, wherein presenting the first visualization comprises presenting a scanning cone on the display concurrently with the first visualization.

While the example clauses described above are described with respect to one particular implementation, it should be understood that, in the context of this document, the content of the example clauses can also be implemented via a method, device, system, a computer-readable medium, and/or another implementation. Additionally, any of examples A-T may be implemented alone or in combination with any other one or more of the examples A-T.

### CONCLUSION

While one or more examples of the techniques described herein have been described, various alterations, additions, permutations and equivalents thereof are included within the scope of the techniques described herein. As can be understood, the components discussed herein are described as divided for illustrative purposes. However, the operations performed by the various components can be combined or performed in any other component. It should also be understood that components or steps discussed with respect to one example or implementation may be used in conjunction with components or steps of other examples.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A method comprising:
receiving, during a scanning session of a physical environment, frames and position and orientation data from a capture device;
estimating, based at least in part on the position and orientation data, frame poses of the capture device;
merging consecutive frames into a current viewpoint bundle; generating, based at least in part on the current viewpoint bundle, a preliminary visualization; and
presenting the preliminary visualization on a display prior to a completion of the scanning session to provide visual feedback regarding three-dimensional model reconstruction.

2. The method of claim 1, wherein presenting the preliminary visualization comprises overlaying the preliminary visualization on a field of view a sensor associated with the capture device.

3. The method of claim 1, wherein presenting the preliminary visualization comprises presenting a scanning cone and a scanning path on the display concurrently with the preliminary visualization.

4. The method of claim 1, wherein the preliminary visualization is at least one of the following:
a solid mesh visualization,
a wireframe visualization,
a point cloud visualization,
a stylized model visualization,
a vertex visualization,
an animated point cloud visualization,
a point cloud and directional light visualization, or
a combined mesh and point cloud visualization.

5. The method of claim 1, wherein the preliminary visualization includes color information that indicates at least one of the following:
height-based characteristics including different colors corresponding to different elevation levels within the physical environment,
quality-based characteristics including different colors corresponding to different confidence levels or detail metrics associated with a state of the scanning session,
object data including different colors corresponding to different objects within the physical environment,
surface continuity including different colors corresponding to different surfaces within the physical environment, or
processing status including different colors corresponding to different stages of data processing or reconstruction completion.

6. The method of claim 1, wherein the preliminary visualization is a first preliminary visualization and the method further comprises replacing the first preliminary visualization with a second preliminary visualization as the second preliminary visualization becomes available.

7. The method of claim 1, further comprising presenting a progress indicator on the display concurrently with the preliminary visualization, the progress indicator indicating a status of post processing operations.

8. One or more computer-readable medium storing instructions that, when executed by one or more processors, cause the one or more processors to perform operations comprising:
receiving, during a scanning session of a physical environment, frames and position and orientation data from a capture device;
generating, during the scanning session, a preliminary visualization;
presenting the preliminary visualization on a display prior to a completion of the scanning session to provide visual feedback to a user;
generating, during post processing operations a secondary visualization;
presenting the secondary visualization on the display;
generating a final visualization; and
presenting the final visualization on the display.

9. The one or more computer-readable medium of claim 8, wherein:
the preliminary visualization is at least one of a point cloud visualization, a wireframe visualization, or a vertex visualization, a solid mesh visualization, a stylized model visualization, a combined mesh and point cloud visualization, a textured model visualization, a three-dimensional doll house model visualization, or a first person viewpoint visualization;
the secondary visualization is at least one of a point cloud visualization, a wireframe visualization, or a vertex visualization, a solid mesh visualization, a stylized model visualization, a combined mesh and point cloud visualization, a textured model visualization, a three-dimensional doll house model visualization, or a first person viewpoint visualization; and
the final visualization is at least one of a point cloud visualization, a wireframe visualization, or a vertex visualization, a solid mesh visualization, a stylized model visualization, a combined mesh and point cloud visualization, a textured model visualization, a three-dimensional doll house model visualization, or a first person viewpoint visualization.

10. The one or more computer-readable medium of claim 8, wherein the secondary visualization includes a series of visualizations associated with different portions of the physical environment, the individual visualizations of the series of visualizations are displayed as post processing operations on each individual portion of the physical environment are completed.

11. The one or more computer-readable medium of claim 10, wherein the displaying the series of visualizations further comprises:
establishing ga width parameter and a height parameter for defining an available screen area of the display; and
determining a zoom associated with the series of visualizations based at least in part on a ratio between the width parameter and height parameter and a width and a height of a bounding box associated with one or more of the portions of the physical environment represented by the series of visualizations.

12. The one or more computer-readable medium of claim 8, wherein the post processing operations further comprise:
partitioning a scanning volume into a plurality of partitions;
generating, for individual partitions of the plurality of partitions, high-poly meshes;
merging the high-poly meshes into a mesh representation; and
texturing the mesh representation to generate the final visualization.

13. The one or more computer-readable medium of claim 8, further comprising presenting a progress indicator on the display concurrently with the secondary visualization, the progress indicator indicating a status of the post processing operations.

14. The one or more computer-readable medium of claim 8, wherein the secondary visualization includes color to indicate planar surface, objects, and height levels within the physical environment.

15. The one or more computer-readable medium of claim 8, wherein the secondary visualization includes a first visualization for a first floor of the physical environment, a second visualization for a second floor of the physical environment, and a third visualization for a combined visualization of the first floor and second floor.

16. A system comprising:
one or more displays;
one or more processors; and
one or more computer readable media storing instructions that, when executed by the one or more processors, cause the one or more processors to perform operations comprising:
receiving first frames of a physical environment from a capture device;
presenting, based at least in part on the first frames and on the display, a first visualization representing a first portion of the physical environment, the first visualization having a first type;
receiving second frames of the physical environment from a capture device;
presenting, based at least in part on the first frames and the second frames and on the display, a second visualization representing a first portion and a second portion of the physical environment, the second visualization having the first type;
processing, the first frames and the second frames, to generate a third visualization representing the first portion and the second portion of the physical environment, the third visualization of a second type different than the first type of the first visualization and the second visualization; and
presenting, on the display over at least a portion of the first visualization or the second visualization, the third visualization.

17. The system of claim 16, wherein the first visualization and the second visualization are point cloud representation and the third visualization is a mesh or wireframe representation.

18. The system of claim 16, the operations further comprising:
further processing, the first frames and the second frames, to generate a fourth visualization representing the first portion and the second portion of the physical environment; and
presenting, on the display over at least a portion of the first visualization or the second visualization, the fourth visualization.

19. The system of claim 16, wherein the first visualization and the second visualization are top down representation and the third visualization is a three-dimensional representation.

20. The system of claim 16, wherein presenting the first visualization comprises presenting a scanning cone on the display concurrently with the first visualization.
